(19) United States
(12) Patent Application Publication
(10) Pub. No.: US 2022/0112427 A1
(43) Pub. Date: Apr. 14, 2022

(54) LIQUID CRYSTAL COMPOSITION, CHOLESTERIC LIQUID CRYSTAL LAYER, CURED SUBSTANCE, OPTICALLY ANISOTROPIC BODY, AND METHOD FOR PRODUCING CHOLESTERIC LIQUID CRYSTAL LAYER

(71) Applicant: FUJIFILM Corporation, Tokyo (JP)

(72) Inventors: Keisuke KODAMA, Minamiashigara-shi (JP); Yuko SUZUKI, Minamiashigara-shi (JP); Shunya KATOH, Minamiashigara-shi (JP)

(73) Assignee: FUJIFILM Corporation, Tokyo (JP)

(21) Appl. No.: 17/560,782

(22) Filed: Dec. 23, 2021

Related U.S. Application Data
(63) Continuation of application No. PCT/JP2020/025259, filed on Jun. 26, 2020.

(30) Foreign Application Priority Data
Jun. 28, 2019 (JP) 2019-122369

(51) Int. Cl. C09K 19/58; G02B 5/30; C09K 19/38

(52) U.S. Cl. CPC C09K 19/588; C09K 19/3852; G02B 5/3016

(57) ABSTRACT

A first objective of the present invention is to provide a liquid crystal composition for forming a cholesteric liquid crystal layer having excellent characteristics capable of reflecting light incident on a layer surface from a normal direction in a direction other than the normal direction. In addition, a second object of the present invention is to provide a cholesteric liquid crystal layer formed of the liquid crystal composition. In addition, a third object of the present invention is to provide a cured substance obtained by curing the liquid crystal composition. In addition, a fourth object of the present invention is to provide an optically anisotropic body formed of the liquid crystal composition, and an optically anisotropic body consisting of the cholesteric liquid crystal layer. In addition, a fifth object of the present invention is to provide a method for producing a cholesteric liquid crystal layer using the liquid crystal composition.

The liquid crystal composition of the present invention contains a liquid crystal compound, a chiral agent A, and a chiral agent B whose helical twisting power increases upon irradiation with light, in which the chiral agent A is a chiral agent that induces a helix in a direction opposite to that of a helix induced by the chiral agent B.

### CROSS-REFERENCE TO RELATED APPLICATIONS

This application is a Continuation of PCT International Application No. PCT/JP2020/025259 filed on Jun. 26, 2020, which claims priority under 35 U.S.C. § 119(a) to Japanese Patent Application No. 2019-122369 filed on Jun. 28, 2019. The above application is hereby expressly incorporated by reference, in its entirety, into the present application.

### BACKGROUND OF THE INVENTION

### 1. Field of the Invention

The present invention relates to a liquid crystal composition, a cholesteric liquid crystal layer, a cured substance, an optically anisotropic body, and a method for producing a cholesteric liquid crystal layer.

### 2. Description of the Related Art

The cholesteric liquid crystal layer is known as a layer having a property of selectively reflecting either dextrorotatory circularly polarized light or levorotatory circularly polarized light in a specific wavelength range. For this reason, the cholesteric liquid crystal layer has been developed for various applications, and is used, for example, as a projected image display member (for example, a reflecting element) such as a projection screen.

Generally, a cholesteric liquid crystalline phase is formed by adding a chiral compound to a nematic liquid crystal. Above all, a binaphthyl derivative is often used as a chiral compound having a strong helical twisting power (HTP).

For example, JP2002-179670A discloses a binaphthyl derivative having a specific structure, as a photoreactive chiral agent which is capable of photoisomerization and, in a case of being added to a liquid crystal compound, is capable of significantly changing a helical structure (twisting power, twisting angle) of the liquid crystal compound upon irradiation with light.

### SUMMARY OF THE INVENTION

Meanwhile, recently, the cholesteric liquid crystal layer is required to have excellent characteristics (diffuse reflectivity) capable of reflecting light incident on a layer surface from a normal direction in a direction other than the normal direction.

Accordingly, an object of the present invention is to provide a liquid crystal composition for forming a cholesteric liquid crystal layer having excellent characteristics capable of reflecting light incident on a layer surface from a normal direction in a direction other than the normal direction.

Another object of the present invention is to provide a cholesteric liquid crystal layer formed of the liquid crystal composition.

Another object of the present invention is to provide a cured substance obtained by curing the liquid crystal composition.

Another object of the present invention is to provide an optically anisotropic body formed of the liquid crystal composition, and an optically anisotropic body consisting of the cholesteric liquid crystal layer.

Another object of the present invention is to provide a method for producing a cholesteric liquid crystal layer formed of the liquid crystal composition.

The present inventors have found that the foregoing objects can be achieved by a predetermined liquid crystal composition containing two predetermined chiral agents having different helical directions to induce (chiral agent A and chiral agent B). The present invention has been completed based on this finding. That is, it has been found that the foregoing objects can be achieved by the following configurations.

[1] A liquid crystal composition comprising:
a liquid crystal compound;
a chiral agent A; and
a chiral agent B whose helical twisting power increases upon irradiation with light,
in which the chiral agent A is a chiral agent that induces a helix in a direction opposite to that of the chiral agent B.

[2] The liquid crystal composition according to [1], in which the chiral agent A is a chiral agent whose helical twisting power decreases upon irradiation with light.

[3] The liquid crystal composition according to [1] or [2], in which the liquid crystal composition is nematically aligned in a case where the liquid crystal compound is aligned into a liquid crystal phase state.

[4] The liquid crystal composition according to any of [1] to [3], in which an absolute value of a weighted average helical twisting power of a chiral agent before light irradiation in the liquid crystal composition is 0.0 to 1.5 μm⁻¹.

[5] The liquid crystal composition according to [1] or [2], in which the liquid crystal composition is cholesterically aligned in the direction of the helix induced by the chiral agent B in a case where the liquid crystal compound is aligned into a liquid crystal phase state.

[6] The liquid crystal composition according to [5], in which the liquid crystal composition satisfies a relationship of Expression (ID), and
each unit of the helical twisting power of the chiral agent A and the helical twisting power of the chiral agent B in Expression (1D) is μm⁻¹, and each unit of a content of the chiral agent A with respect to the liquid crystal compound and a content of the chiral agent B with respect to the liquid crystal compound in Expression (1D) is % by mass.

Expression (1D): helical twisting power of chiral agent A×content of chiral agent A with respect to liquid crystal compound<helical twisting power of chiral agent B x content of chiral agent B with respect to liquid crystal compound

[7] The liquid crystal composition according to any one of [1] to [6], in which the liquid crystal compound has at least one or more polymerizable groups.

[8] The liquid crystal composition according to any one of [1] to [7], in which at least one of the chiral agent A or the chiral agent B has a partial structure of any one of a binaphthyl partial structure, an isosorbide partial structure, or an isomannide partial structure.

[9] The liquid crystal composition according to any one of [1] to [8], in which at least one of the chiral agent A or the chiral agent B has a photoisomerizable double bond.

[10] The liquid crystal composition according to any one of [1] to [9], in which the chiral agent B is a compound represented by General Formula (1) which will be described later.

[11] A cholesteric liquid crystal layer formed of the liquid crystal composition according to any one of [1] to [10].

[12] The cholesteric liquid crystal layer according to [11], in which an arrangement direction of bright portions and dark portions derived from a cholesteric liquid crystalline phase, as observed under a scanning electron microscope in a cross section perpendicular to a main surface of the cholesteric liquid crystal layer, is tilted with respect to a normal line of the main surface of the cholesteric liquid crystal layer.

[13] The cholesteric liquid crystal layer according to [11], in which bright portions and dark portions derived from a cholesteric liquid crystalline phase, as observed under a scanning electron microscope in a cross section perpendicular to a main surface of the cholesteric liquid crystal layer, are wave-like.

[14] A cured substance obtained by curing the liquid crystal composition according to any one of [1] to [10].

[15] An optically anisotropic body formed of the liquid crystal composition according to any one of [1] to [10].

[16] An optically anisotropic body consisting of the cholesteric liquid crystal layer according to any one of [11] to [13].

[17]A method for producing a cholesteric liquid crystal layer, comprising:
a step 1 of forming a composition layer using the liquid crystal composition according to any one of [1] to [10];
a step 2 of aligning the liquid crystal compound contained in the composition layer into a liquid crystal phase; and
a step 3 of irradiating at least a partial region of the composition layer with light to increase the helical twisting power of the chiral agent B in a light-irradiated region.

[18] The method for producing a cholesteric liquid crystal layer according to [17], in which the step 2 is a step of aligning the liquid crystal compound contained in the composition layer into a nematic liquid crystal phase,
the step 3 is a step of increasing the helical twisting power of the chiral agent B in the light-irradiated region to bring an alignment state of the liquid crystal compound into a cholesteric liquid crystalline phase, and
the cholesteric liquid crystal layer is obtained through the steps 1 to 3 such that an arrangement direction of bright portions and dark portions derived from the cholesteric liquid crystalline phase, as observed under a scanning electron microscope in a cross section perpendicular to a main surface of the cholesteric liquid crystal layer, is tilted with respect to a normal line of the main surface of the cholesteric liquid crystal layer.

[19] The method for producing a cholesteric liquid crystal layer according to [17], in which the step 2 is a step of aligning the liquid crystal compound contained in the composition layer into a cholesteric liquid crystalline phase,
the step 3 is a step of increasing the helical twisting power of the chiral agent B in the light-irradiated region to reduce a helical pitch of the cholesteric liquid crystalline phase, and
the cholesteric liquid crystal layer is obtained through the steps 1 to 3 such that bright portions and dark portions derived from the cholesteric liquid crystalline phase, as observed under a scanning electron microscope in a cross section perpendicular to a main surface of the cholesteric liquid crystal layer, are wave-like.

According to an aspect of the present invention, it is possible to provide a liquid crystal composition for forming a cholesteric liquid crystal layer having excellent characteristics capable of reflecting light incident on a layer surface from a normal direction in a direction other than the normal direction.

In addition, according to the aspect of the present invention, it is possible to provide a cholesteric liquid crystal layer formed of the liquid crystal composition.

In addition, according to the aspect of the present invention, it is possible to provide a cured substance obtained by curing the liquid crystal composition.

In addition, according to the aspect of the present invention, it is possible to provide an optically anisotropic body formed of the liquid crystal composition and an optically anisotropic body consisting of the cholesteric liquid crystal layer.

In addition, according to the aspect of the present invention, it is possible to provide a method for producing a cholesteric liquid crystal layer formed of the liquid crystal composition.

### BRIEF DESCRIPTION OF THE DRAWINGS

FIG. 1 is a schematic diagram of a cross section of a cholesteric liquid crystal layer according to a first embodiment observed with a scanning electron microscope (SEM).

FIG. 2 is a schematic diagram of a graph plotting a relationship between a helical twisting power (HTP) (μm⁻¹)×a concentration (% by mass) and a light irradiation amount (mJ/cm²) for each of chiral agent Al and chiral agent B.

FIG. 3 is a schematic diagram of a graph plotting a relationship between a weighted average helical twisting power (μm⁻¹) and a light irradiation amount (mJ/cm²) in a system in which chiral agent Al and chiral agent B are used in combination.

FIG. 4 is a schematic diagram of a graph plotting a relationship between a helical twisting power (HTP) (μm⁻¹)×a concentration (% by mass) and a light irradiation amount (mJ/cm²) for each of chiral agent A2 and chiral agent B.

FIG. 5 is a schematic diagram of a graph plotting a relationship between a weighted average helical twisting power (μm⁻¹) and a light irradiation amount (mJ/cm²) in a system in which chiral agent A2 and chiral agent B are used in combination.

FIG. 6 is a schematic diagram of a cross section of a cholesteric liquid crystal layer according to a second embodiment observed by SEM.

### DESCRIPTION OF THE PREFERRED EMBODIMENTS

Hereinafter, the present invention will be described in more detail.

The description of the configuration requirements described below may be made based on a typical embodiment of the present invention, but the present invention is not limited to such an embodiment.

In the present specification, the numerical range expressed by using “to” means a range including numerical values described before and after “to” as a lower limit value and an upper limit value, respectively.

In addition, in the present specification, the term “(meth)acrylate” is a notation representing both acrylate and methacrylate, the term “(meth)acryloyl group” is a notation representing both an acryloyl group and a methacryloyl group, and the term “(meth)acrylic” is a notation representing both acrylic and methacrylic.

In a case where substitution or non-substitution is not explicitly indicated in the description of a group (a group of atoms) in the present specification, the group includes both a group having no substituent and a group having a substituent. For example, the term “alkyl group” includes not only an alkyl group having no substituent (unsubstituted alkyl group) but also an alkyl group having a substituent (substituted alkyl group).

In the present specification, in a case where it is simply referred to as a substituent, examples of the substituent include Substituent T shown below.

(Substituent T)

Examples of the Substituent T include a halogen atom (such as a fluorine atom, a chlorine atom, a bromine atom, or an iodine atom), an alkyl group, a cycloalkyl group, an alkenyl group, a cycloalkenyl group, an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an amino group (including an alkylamino group and an anilino group), an acylamino group, an aminocarbonylamino group, an alkoxycarbonylamino group, an aryloxycarbonylamino group, a sulfamoylamino group, an alkylsulfonylamino or arylsulfonylamino group, a mercapto group, an alkylthio group, an arylthio group, a heterocyclic thio group, a sulfamoyl group, a sulfo group, an alkylsulfinyl or arylsulfinyl group, an alkylsulfonyl or arylsulfonyl group, an acyl group, an aryloxycarbonyl group, an alkoxycarbonyl group, a carbamoyl group, an aryl or heterocyclic azo group, an imido group, a phosphino group, a phosphinyl group, a phosphinyloxy group, a phosphinylamino group, a silyl group, and a group containing a polymerizable group (for example, a suitable specific example is a group represented by General Formula (T)).

General Formula (T): *−L_{T}−P_{T}

In General Formula (T), L_{T} represents a single bond or a divalent linking group. P_{T} represents a polymerizable group represented by General Formulae (P-1) to (P-20) which will be described later.

The divalent linking group represented by L_{T} is not particularly limited, and is preferably an alkylene group which may contain a heteroatom, more preferably an alkylene group having 1 to 10 carbon atoms which may contain an oxygen atom, and still more preferably an alkylene group having 1 to 6 carbon atoms which may contain an oxygen atom.

In General Formulae (P-1) to (P-20) shown below, * represents a bonding position. In addition, Ra represents a hydrogen atom or a methyl group. In addition, Me represents a methyl group and Et represents an ethyl group.

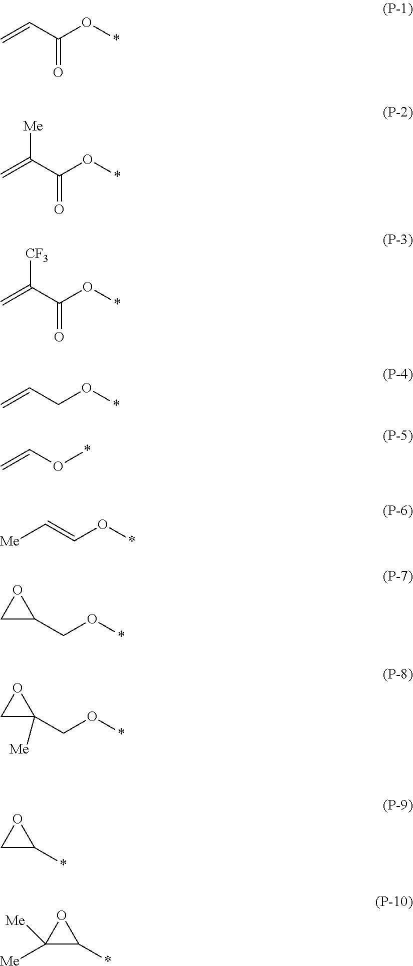

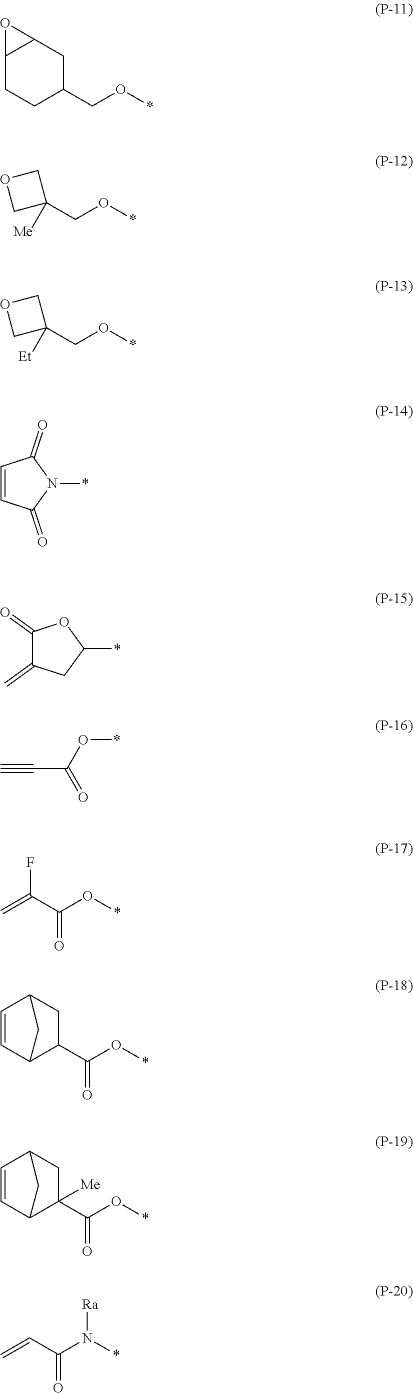

Among the above-mentioned substituents, those having a hydrogen atom may be further substituted with any of the above-mentioned substituents in the portion of the hydrogen atom in the substituent.

The bonding direction of the divalent groups described in the present specification is not limited unless otherwise specified. For example, in a case where M is —OCO—C(CN)═CH— in a compound represented by the general formula “L-M-N”, M may be *1—OCO—C(CN)═CH—*2 or may be *1—CH═C(CN)—COO—*2, assuming that the position bonded to the L side is *1 and the position bonded to the N side is *2. In addition, for example, in a case where M is —COO—, M may be *1—COO—*2 or may be *1—OCO—*2, assuming that the position bonded to the L side is *1 and the position bonded to the N side is *2.

[Liquid Crystal Composition]

The liquid crystal composition according to the embodiment of the present invention contains a liquid crystal compound, a chiral agent A, and a chiral agent B whose helical twisting power increases upon irradiation with light, in which the chiral agent A is a chiral agent that induces a helix in a direction opposite to that of the chiral agent B.

With the above configuration, the cholesteric liquid crystal layer formed of the liquid crystal composition according to the embodiment of the present invention has excellent characteristics (diffuse reflectivity) capable of reflecting light incident on a layer surface from a normal direction in a direction other than the normal direction. The diffuse reflectivity includes directional diffuse reflectivity having a high reflection intensity in a specific direction other than the normal direction, as will be described later and omnidirectional diffuse reflectivity having no directivity, as described above.

In the following, first, individual components contained in the liquid crystal composition will be described, and then the cholesteric liquid crystal layer according to the embodiment of the present invention will be described.

In the following description of the cholesteric liquid crystal layer according to the embodiment of the present invention, a cholesteric liquid crystal layer exhibiting reflection having a large diffraction angle (that is, a cholesteric liquid crystal layer having excellent high diffraction angle reflectivity) and a method for producing the same will be described as the first embodiment; and a cholesteric liquid crystal layer capable of omnidirectional diffuse reflection (that is, a cholesteric liquid crystal layer capable of diffuse reflection in various angular directions with suppressed reflection directivity) and a method for producing the same will be described as the second embodiment. Here, the “cholesteric liquid crystal layer exhibiting reflection having a large diffraction angle” is intended to refer to a cholesteric liquid crystal layer having a large angle exhibiting a maximum reflectance with respect to an incident direction of light incident on the cholesteric liquid crystal layer. The cholesteric liquid crystal layer exhibiting reflection having a large diffraction angle as described above corresponds to a cholesteric liquid crystal layer exhibiting directional diffuse reflectivity having a high reflection intensity in a specific direction other than the normal direction.

In the following description, the helical twisting power (HTP) of a chiral agent is a factor indicating a helical alignment ability represented by Expression (1A).

HTP=1/(length of helical pitch (unit: μm)×concentration of chiral agent with respect to liquid crystal compound (% by mass)) [μm⁻¹] Expression (1A)

The length of the helical pitch refers to a length of pitch P (=the period of the helix) of a helical structure of the cholesteric liquid crystalline phase and can be measured by the method described in Handbook of Liquid Crystals (published by Maruzen Co., Ltd.), p. 196.

In addition, the value of HTP is influenced not only by the type of chiral agent but also by the type of liquid crystal compound contained in the composition. Therefore, for example, in a case where a composition containing a predetermined chiral agent X and a liquid crystal compound P1 and a composition containing a predetermined chiral agent X and a liquid crystal compound P2 different from the liquid crystal compound P1 are prepared, and HTPs of both compositions are measured at the same temperature, the values of HTPs thus measured may be different therebetween.

In addition, the helical twisting power (HTP) of the chiral agent is also represented as Expression (1B).

HTP=(average refractive index of liquid crystal compound)/{(concentration of chiral agent with respect to liquid crystal compound (% by mass))×(central reflection wavelength (nm))} [μm⁻¹] Expression (1B)

In a case where the liquid phase composition contains two or more chiral agents, the “concentration of chiral agent in liquid crystal composition” in Expression (IA) and Expression (1B) corresponds to the sum of the concentrations of all chiral agents.

[Various Components]

Hereinafter, various components that the liquid crystal composition according to the embodiment of the present invention contains indispensably and optionally will be described.

<Liquid Crystal Compound>

The type of the liquid crystal compound is not particularly limited, and known liquid crystal compounds can be used.

Generally, liquid crystal compounds can be classified into a rod-like type (rod-like liquid crystal compound) and a disk-like type (discotic liquid crystal compound, disk-like liquid crystal compound) depending on the shape thereof. Further, the rod-like type and the disk-like type are each classified into a low molecular weight type and a high molecular weight type. The high molecular weight generally refers to having a polymerization degree of 100 or more (Polymer Physics-Phase Transition Dynamics, Masao Doi, p. 2, Iwanami Shoten Publishers, 1992). Any liquid crystal compound can be used in the present invention. In addition, two or more liquid crystal compounds may be used in combination.

The liquid crystal compound preferably has at least one or more polymerizable groups.

The type of the polymerizable group is not particularly limited, and is preferably a functional group capable of an addition polymerization reaction and more preferably a polymerizable ethylenic unsaturated group or a cyclic polymerizable group. More specifically, the polymerizable group is preferably a (meth)acryloyl group, a vinyl group, a styryl group, an allyl group, an epoxy group, or an oxetane group, and more preferably a (meth)acryloyl group.

<Chiral Agent>

The liquid crystal composition according to the embodiment of the present invention contains a chiral agent A and a chiral agent B as the chiral agent.

The chiral agent A and the chiral agent B may be liquid crystalline or non-liquid crystalline. In addition, the chiral agent A and the chiral agent B may be a chiral agent containing an asymmetric carbon atom, or may be an axially asymmetric compound or planarly asymmetric compound containing no asymmetric carbon atom.

The chiral agent A is a chiral agent that induces a helix in a direction opposite to that of a helix induced by the chiral agent B. That is, in a case where the chiral agent A is a chiral agent that induces a right-handed (dextrorotatory) helix, the chiral agent B is a chiral agent that induces a left-handed (levorotatory) helix.

In addition, the chiral agent B is a chiral agent whose helical twisting power increases upon irradiation with light.

The “light” in the present specification means an actinic ray or radiation, for example, an emission line spectrum of a mercury lamp, a far ultraviolet ray typified by an excimer laser, an extreme ultraviolet ray (EUV light), an X-ray, an ultraviolet ray, or an electron beam (EB). Of these, an ultraviolet ray is preferable.

Above all, the chiral agent A is preferably a chiral agent whose helical twisting power decreases upon irradiation with light.

The “increase and decrease of helical twisting power” in the present specification means an increase/decrease in a case where an initial helical direction (before light irradiation) of each of the chiral agent A and the chiral agent B is set to “positive”. Therefore, even in a case where the helical twisting power of a chiral agent continues to decrease and goes below zero upon irradiation with light and therefore the helical direction becomes “negative” (that is, even in a case where a chiral agent induces a helix in a helical direction opposite to an initial helical direction (before light irradiation)), such a chiral agent also corresponds to a “chiral agent whose helical twisting power decreases”.

The chiral agent whose helical twisting power decreases upon irradiation with light may be, for example, a so-called photoreactive chiral agent. The photoreactive chiral agent is a compound which has a chiral moiety and a photoreactive moiety that undergoes a structural change upon irradiation with light and, for example, greatly changes a twisting power of a liquid crystal compound according to the light irradiation amount.

Examples of the photoreactive moiety that undergoes a structural change upon irradiation with light include photochromic compounds (Kingo Uchida and Masahiro Irie, “Chemical Industry”, Vol. 64, p. 640, 1999, and Kingo Uchida and Masahiro Irie, “Fine Chemicals”, Vol. 28(9), p. 15, 1999). In addition, the structural change means decomposition, addition reaction, isomerization, dimerization reaction, or the like occurred upon irradiation of a photoreactive moiety with light, and the structural change may be irreversible. In addition, the chiral moiety corresponds to an asymmetric carbon described in Chemistry of Liquid Crystal, No. 22, Hiroyuki Nohira, Chemistry Review, p.73, 1994.

Examples of the photoreactive chiral agent include photoreactive chiral agents described in paragraphs 0044 to 0047 of JP2001-159709A, optically active compounds described in paragraphs 0019 to 0043 of JP2002-179669A, optically active compounds described in paragraphs 0020 to 0044 of JP2002-179633A, optically active compounds described in paragraphs 0016 to 0040 of JP2002-179670A, optically active compounds described in paragraphs 0017 to 0050 of JP2002-179668A, optically active compounds described in paragraphs 0018 to 0044 of JP2002-180051A, optically active compounds described in paragraphs 0016 to 0055 of JP2002-338575A, and optically active compounds in paragraphs 0020 to 0049 of JP2002-179682A.

It is preferable that at least one of the chiral agent A or the chiral agent B has a photoisomerizable double bond from the viewpoint that the amount of increase in the helical twisting power of the liquid crystal composition upon irradiation with light is more excellent.

Above all, it is more preferable that the chiral agent A has a double bond capable of trans photoisomerization from the viewpoint that the initial helical twisting power (before light irradiation) is high and the amount of decrease in the helical twisting power upon irradiation with light is more excellent. In addition, it is preferable that the chiral agent B has a double bond capable of cis photoisomerization from the viewpoint that the initial helical twisting power (before light irradiation) is low and the amount of increase in the helical twisting power upon irradiation with light is more excellent.

In addition, at least one of the chiral agent A or the chiral agent B preferably has any partial structure selected from a binaphthyl partial structure, an isosorbide partial structure (a partial structure derived from isosorbide), and an isomannide partial structure (a partial structure derived from isomannide), and more preferably a binaphthyl partial structure. The binaphthyl partial structure, the isosorbide partial structure, and the isomannide partial structure are intended to have the following structures, respectively.

The portion of the binaphthyl partial structure in which the solid line and the broken line are parallel to each other represents a single bond or a double bond. The case where the portion where the solid line and the broken line are parallel to each other is a single bond, and the case where the portion where the solid line and the broken line are parallel to each other is a double bond each have the same definition as the portion where the solid line and the broken line are parallel to each other in General Formula (1) which will be described later. In addition, the chiral agent containing a binaphthyl partial structure is also intended to include a compound represented by General Formula (1) which will be described later. That is, the chiral agent containing the binaphthyl partial structure shown below may have a configuration in which the binaphthyl partial structure is further condensed with another ring structure such that R¹ and R² may be bonded to each other to form a ring structure in General Formula (1) which will be described later. In the structure shown below, * represents a bonding position.

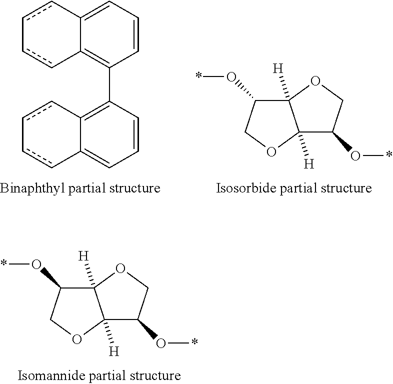

In addition, the chiral agent B is preferably a compound represented by General Formula (1) from the viewpoint that the amount of increase in the helical twisting power of the liquid crystal composition upon irradiation with light is more excellent.

(General Formula (1))

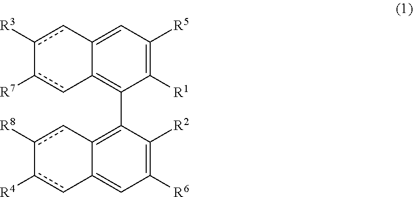

In General Formula (1), the portion where the solid line and the broken line are parallel to each other represents a single bond or a double bond. R¹ to R⁸ each independently represent a hydrogen atom or a monovalent substituent, provided that at least one of R¹, . . . , or R⁸ represents a monovalent substituent represented by General Formula (2). R¹ and R² may be bonded to each other to form a ring structure.

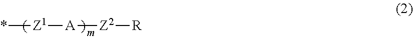

In General Formula (2), A represents an aromatic or aliphatic hydrocarbon ring group having 5 to 10 ring members, which may have a substituent, or an aromatic or aliphatic heterocyclic group having 5 to 10 ring members, which may have a substituent. Z¹ and Z² each independently represent a single bond or a divalent linking group. m represents an integer of 0 to 5. R represents a hydrogen atom or a monovalent substituent. * represents a bonding position. In General Formula (2), in a case where m is an integer of 2 or more, a plurality of Z¹'s and a plurality of A′s may be respectively the same or different from each other.

In General Formula (1), the portion where the solid line and the broken line are parallel to each other represents a single bond or a double bond. For example, in a case where the portion where the solid line and the broken line are parallel to each other is a double bond, the compound represented by General Formula (1) corresponds to a compound represented by General Formula (1-1); and in a case where the portion where the solid line and the broken line are parallel to each other is a single bond, the compound represented by General Formula (1) corresponds to a compound represented by General Formula (1-2).

Above all, the compound represented by General Formula (1) is preferably a compound represented by General Formula (1-1).

R¹ to R⁸ in General Formula (1-1) and General Formula (1-2) each have the same definition as R¹ to R⁸ in General Formula (1).

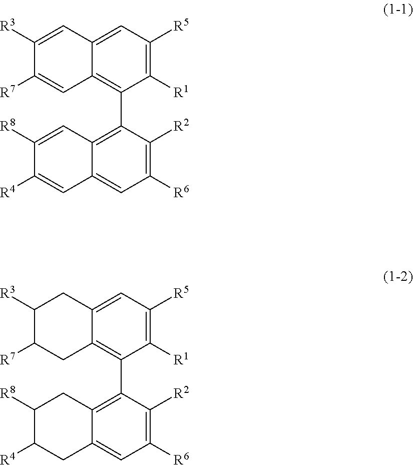

In General Formula (1), R¹ to R⁸ each independently represent a hydrogen atom or a monovalent substituent.

The monovalent substituent represented by R¹ to R⁸ is not particularly limited, and examples thereof include the groups exemplified as the Substituent T, provided that at least one of R¹, . . . , or R⁸ represents a monovalent substituent represented by General Formula (2) which will be described later.

In General Formula (2), in a case where m is an integer of 2 or more, a plurality of Z¹'s and a plurality of A's may be respectively the same or different from each other.

Above all, in General Formula (1), it is preferable that both R¹ and R² represent a substituent represented by General Formula (2), or both R³ and R⁴ represent a substituent represented by General Formula (2), or both R⁵ and R⁶ represent a substituent represented by General Formula (2), and it is more preferable that both R¹ and R² represent a substituent represented by General Formula (2), or both R³ and R⁴ represent a substituent represented by General Formula (2).

R¹ and R² may be bonded to each other to form a ring structure.

In a case where R¹ and R² are bonded to each other to form a ring structure, the ring is not particularly limited and may be either an aromatic ring or a non-aromatic ring, among which a non-aromatic ring is preferable.

In a case where R¹ and R² are linked to each other to form a ring, a group to which R¹ and R² are linked to each other is, for example, preferably a *—L^{S1}-divalent aromatic hydrocarbon ring group-L^{S2}—* or *—L^{S3}-divalent aliphatic hydrocarbon group-L^{S4}—*. * represents a bonding position to a binaphthyl partial structure in General Formula (1).

The aromatic hydrocarbon ring group is not particularly limited, and examples thereof include the same aromatic hydrocarbon ring group represented by A in General Formula (2) which will be described later. Above all, a benzene ring group is preferable.

The aliphatic hydrocarbon group is not particularly limited, and examples thereof include a linear or branched alkylene group having 1 to 6 carbon atoms.

^{Lsl} _{and} ^{LS2} each independently represent a single bond or a divalent linking group.

The divalent linking group represented by L^{S1} and L^{S2} is not particularly limited, and examples thereof include a divalent aliphatic hydrocarbon group (which may be linear, branched, or cyclic and preferably has 1 to 20 carbon atoms, and which includes, for example, an alkylene group, an alkenylene group, and an alkynylene group), —O—, —S—, —SO₂—, —NR^{D}—, —CO—, —N═N—, —CH═N—, and a group formed by combining two or more of these groups (which includes, for example, —CO—NH—, —CO—S—, —CH₂O—, and —COO—). Here, R^{D} represents a hydrogen atom or an alkyl group (preferably having 1 to 10 carbon atoms).

The hydrogen atom in the divalent linking group may be substituted with another substituent such as a halogen atom.

L^{S1} and L^{S2} are each preferably a single bond, a divalent aliphatic hydrocarbon group, —O—, —CO—, —CO—NH—, or —COO—.

L^{S3} and LS⁴ each independently represent a single bond or a divalent linking group.

The divalent linking group represented by L^{S3} and L^{S4} is not particularly limited, and examples thereof include —O—, —S—, —SO₂—, —NR^{D}—, —CO—, —N═N—, —CHN—, and a group formed by combining two or more of these groups (which includes, for example, —CO—NH—, —CO—S—, and —COO—). Here, R^{D} represents a hydrogen atom or an alkyl group (preferably having 1 to 10 carbon atoms).

The hydrogen atom in the divalent linking group may be substituted with another substituent such as a halogen atom.

L^{S3} and L^{S4} are each preferably a single bond, —O—, —CO—, —CO—NH—, or —COO—.

General Formula (2) will be described below.

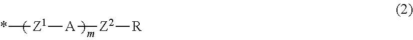

In General Formula (2), A represents an aromatic or aliphatic hydrocarbon ring group having 5 to 10 ring members, which may have a substituent, or an aromatic or aliphatic heterocyclic group having 5 to 10 ring members, which may have a substituent.

Z¹ and Z² each independently represent a single bond or a divalent linking group. m represents an integer of 0 to 5. R represents a hydrogen atom or a monovalent substituent.

In General Formula (2), the aromatic hydrocarbon ring constituting the aromatic hydrocarbon ring group having 5 to 10 ring members represented by A may have either a monocyclic structure or a polycyclic structure. In a case where the aromatic hydrocarbon ring has a polycyclic structure, it is preferable that at least one of the rings contained in the polycyclic structure is a 5- or higher membered ring.

The number of ring members in the aromatic hydrocarbon ring is preferably 6 to 10. Specific examples of the aromatic hydrocarbon ring include a benzene ring and a naphthalene ring, among which a benzene ring is more preferable.

In General Formula (2), the aliphatic hydrocarbon ring constituting the aliphatic hydrocarbon ring group having 5 to 10 ring members represented by A may have either a monocyclic structure or a polycyclic structure. In a case where the aliphatic hydrocarbon ring has a polycyclic structure, it is preferable that at least one of the rings contained in the polycyclic structure is a 5- or higher membered ring.

The number of ring members in the aliphatic hydrocarbon ring is preferably 5 or 6. Specific examples of the aliphatic hydrocarbon ring include a cyclopentane ring, a cyclohexane ring, a cycloheptane ring, a cyclooctane ring, a norbornene ring, and an adamantanc ring. Of these, a cyclopentane ring or a cyclohexane ring is preferable.

In General Formula (2), the aromatic or aliphatic hydrocarbon ring group having 5 to 10 ring members represented by A may have a substituent. The substituent is not particularly limited, and examples thereof include the groups exemplified as the Substituent T.

In General Formula (2), the aromatic heterocyclic ring constituting the aromatic heterocyclic group having 5 to 10 ring members represented by A may have either a monocyclic structure or a polycyclic structure. In a case where the aromatic heterocyclic ring has a polycyclic structure, it is preferable that at least one of the rings contained in the polycyclic structure is a 5- or higher membered ring.

Examples of the heteroatom contained in the aromatic heterocyclic ring include a nitrogen atom, an oxygen atom, and a sulfur atom. The number of heteroatoms contained in the aromatic heterocyclic ring is, for example, 1 to 3, preferably 1 or 2.

The number of ring members in the aromatic heterocyclic ring is preferably 6.

Specific examples of the aromatic heterocyclic ring include a pyridine ring, a pyridazine ring, a pyrimidine ring, a pyrazine ring, a triazine ring, a thiophene ring, a thiazole ring, an imidazole ring, and a coumarin ring.

In General Formula (2), the aliphatic heterocyclic ring constituting the aliphatic heterocyclic group having 5 to 10 ring members represented by A may have either a monocyclic structure or a polycyclic structure. In a case where the aliphatic heterocyclic ring has a polycyclic structure, it is preferable that at least one of the rings contained in the polycyclic structure is a 5- or higher membered ring.

Examples of the heteroatom contained in the aliphatic heterocyclic ring include a nitrogen atom, an oxygen atom, and a sulfur atom. The number of heteroatoms contained in the aliphatic heterocyclic ring is, for example, 1 to 3, preferably 1 or 2.

The number of ring members of the aliphatic heterocyclic ring is preferably 5 or 6.

Specific examples of the aliphatic heterocyclic ring include an oxolane ring, an oxane ring, a piperidine ring, and a piperazine ring. The aliphatic heterocyclic ring may be one in which —CH₂— constituting the ring is substituted with —CO—, and examples thereof include a phthalimide ring.

In General Formula (2), the aromatic or aliphatic heterocyclic group having 5 to 10 ring members represented by A may have a substituent. The substituent is not particularly limited, and examples thereof include the groups exemplified as the Substituent T.

In General Formula (2), the divalent linking group represented by Z¹ and Z² is not particularly limited and examples thereof include a divalent aliphatic hydrocarbon group (which may be linear, branched, or cyclic and preferably has 1 to 20 carbon atoms, and which includes, for example, an alkylene group, an alkenylene group, and an alkynylene group), —O—, —S—, —SO₂—, —NR^{D}—, —CO—, —N═N—, —CH═N—, and a group formed by combining two or more of these groups (which includes, for example, —CO—NH—, —CO—S—, —CH₂O—, and —COO—). Here, R^{D} represents a hydrogen atom or an alkyl group (preferably having 1 to 10 carbon atoms).

The hydrogen atom in the divalent linking group may be substituted with another substituent (examples of which include the groups exemplified as the Substituent T) such as a halogen atom.

Above all, the divalent linking group represented by Z¹ is preferably one selected from the group consisting of a divalent aliphatic hydrocarbon group, —O—, —CO—, and —NH—, or a group formed by combining two or more of these groups, more preferably —CR^{E}═CR^{E}—, —O—, —CO—, —CO—NH—, or —COO—, and still more preferably —CR^{E}═CR^{E}—. R^{E} represents a hydrogen atom or a substituent. Examples of the substituent represented by R^{E} include the groups exemplified as the Substituent T.

Above all, the divalent linking group represented by Z² is preferably —O—, —CO—, —CO—NH—, or —COO—.

In General Formula (2), in a case where the divalent linking group represented by Z¹ is —CR^{E}═CR^{E}—, it may be in cis or trans configuration. That is, for example, in a case where Z¹ represents —CR^{E}═CR^{E}— and m represents 1 in General Formula (2), the positional relationship between the group represented by “—A—Z²—R” and the bonding position represented by “—*” is not particularly limited; and the group represented by “—A—Z²—R” and the bonding position represented by “—*” may be arranged in a trans configuration at “—CR^{E}═CR^{E}—” (the group represented by “—A—Z²—R” and the bonding position represented by “—*” are located on the opposite side with respect to the double bond) or may be arranged in a cis configuration at “—CR^{E}═CR^{E}—” (the group represented by “—A—Z²—R” and the bonding position represented by “—*” are located on the same side with respect to the double bond).

In General Formula (2), in a case where the divalent linking group represented by Z¹ is —CR^{E}═CR^{E}—, the —CR^{E}═CR^{E}— corresponds to a photoisomerizable double bond.

In General Formula (2), m is preferably 1 to 3, more preferably 1 or 2, and still more preferably 1.

In General Formula (2), the monovalent substituent represented by R is not particularly limited, and examples thereof include the groups exemplified as the Substituent T (among which an alkyl group or a group represented by General Formula (T) is preferable).

From the viewpoint that the amount of increase in the helical twisting power after exposure to light is more excellent, with regard to General Formula (1), it is preferable that R¹ and R² are bonded to each other to form a ring structure, and both R³ and R⁴ represent a substituent represented by General Formula (2); it is more preferable that R¹ and R² are bonded to each other to form a ring structure, both R³ and R⁴ represent a substituent represented by General Formula (2), m represents 1, and Z¹ represents —CR^{E}═CR^{E}—; and it is still more preferable that R¹ and R² are bonded to each other to form a ring structure, both R³ and R⁴ represent a substituent represented by General Formula (2), m represents 1, Z¹ represents —CR^{E}═CR^{E}—, and the positional relationship between the group represented by “—A—Z²—R” and the bonding position represented by “—*” is in a cis configuration.

In addition, the compound represented by General Formula (1) is preferably a compound represented by General Formula (1-1) from the viewpoint that the amount of increase in the helical twisting power after exposure to light is more excellent.

Hereinafter, specific examples of the chiral agent A will be shown, but the present invention is not limited thereto.

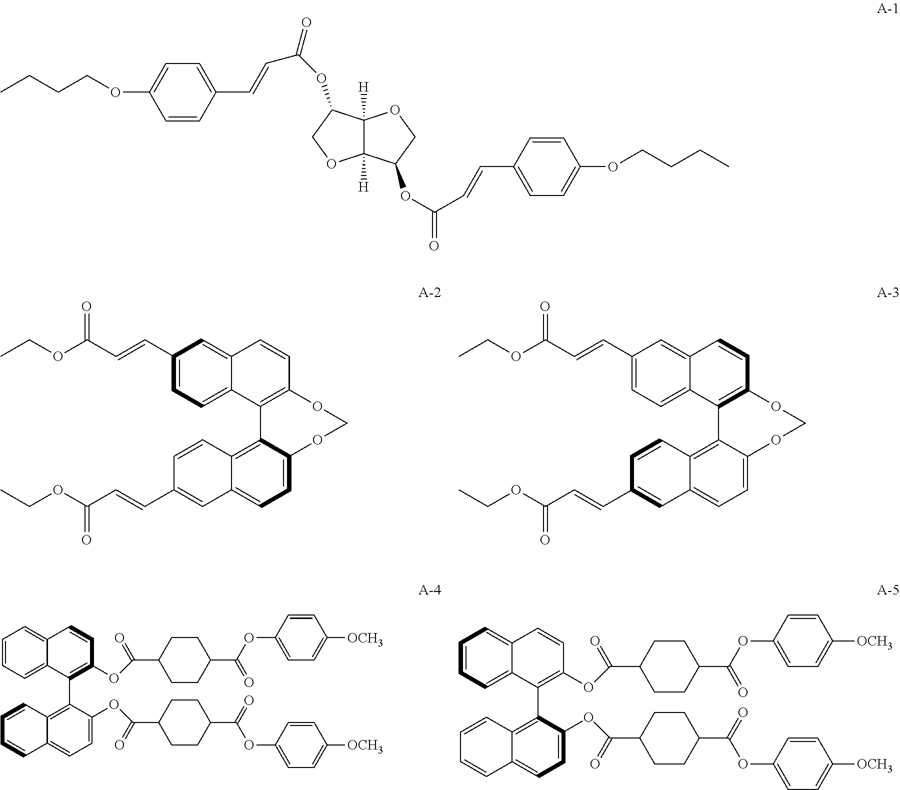

Hereinafter, specific examples of the chiral agent B will be described, but the present invention is not limited thereto.

TABLE 1

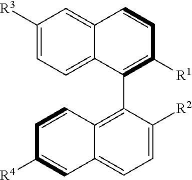

| Table 1 | R¹ | R² | R³ | R⁴ |
|---|---|---|---|---|
| B-(1) | 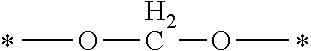 | | 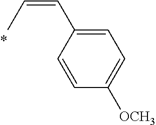 | 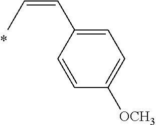 |
| B-(2) | 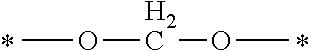 | | 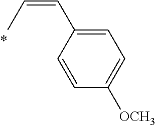 | 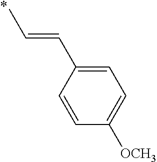 |
| B-(3) | 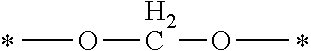 | | 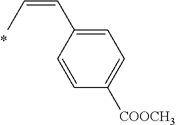 | 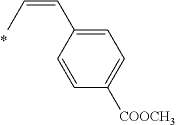 |
| B-(4) | 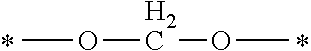 | | 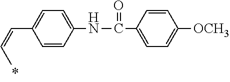 | 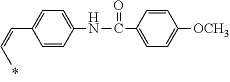 |
| B-(5) | 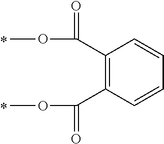 | | 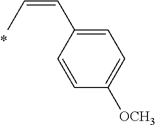 | 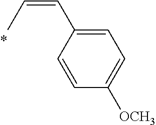 |
| B-(6) | 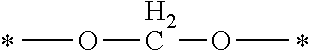 | | 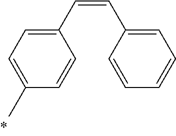 | 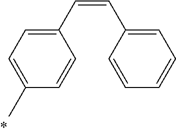 |
| B-(7) | 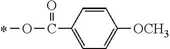 | 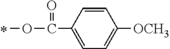 | 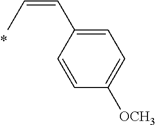 | 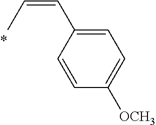 |
| B-(8) | OCH₃ | OCH₃ | 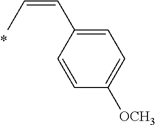 | 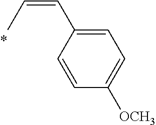 |
| B-(9) | 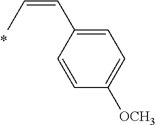 | 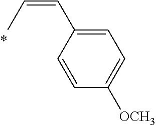 | H | H |
| B-(10) | 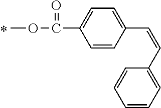 | 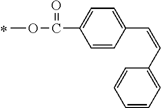 | H | H |

TABLE 2

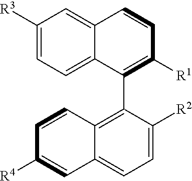

| | | | | |
|---|---|---|---|---|
| Table 2 | R¹ | R² | R³ | R⁴ |

| | | | |
|---|---|---|---|
| B-(11) | 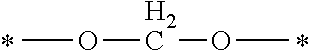 | 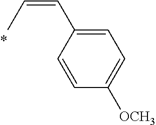 | H |
| B-(12) | 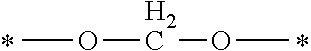 | 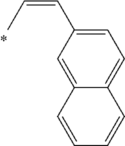 | 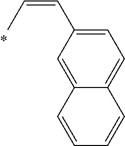 |
| B-(13) | 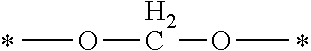 | 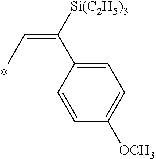 | 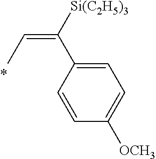 |
| B-(14) | 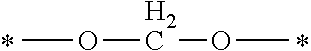 | 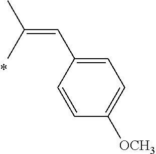 | 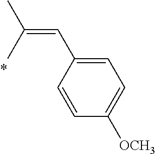 |
| B-(15) | 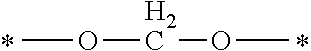 | 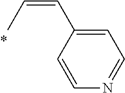 | 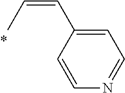 |
| B-(16) | 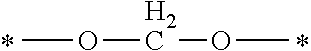 | 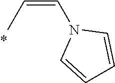 | 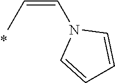 |

TABLE 3

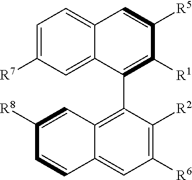

| | | | | | | |
|---|---|---|---|---|---|---|
| Table 3 | R¹ | R² | R⁵ | R⁶ | R⁷ | R⁸ |

| | | | | | |
|---|---|---|---|---|---|
| B-(17) | 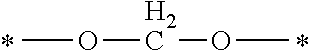 | 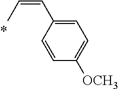 | 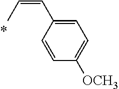 | H | H |
| B-(18) | 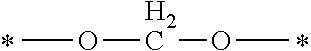 | H | H | 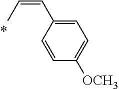 | 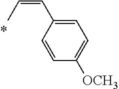 |

TABLE 4

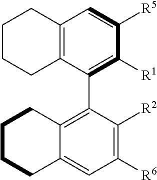

| | R¹ | R² | R⁵ | R⁶ |
|---|---|---|---|---|
| B-(19) | 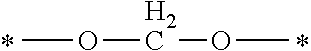 | | 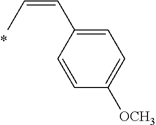 | 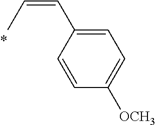 |
| B-(20) | 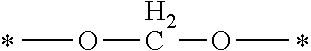 | | 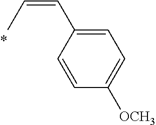 | 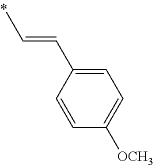 |
| B-(21) | 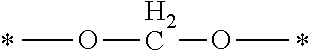 | | 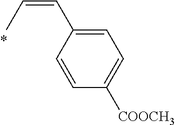 | 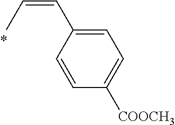 |
| B-(22) | | | 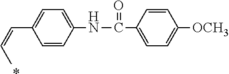 | 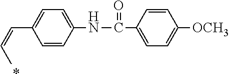 |
| B-(23) | 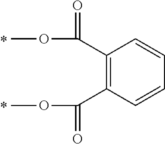 | | 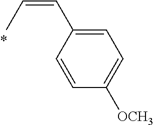 | 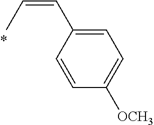 |
| B-(24) | 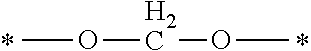 | | 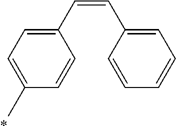 | 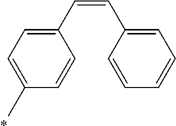 |
| B-(25) | 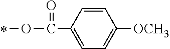 | 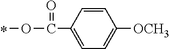 | 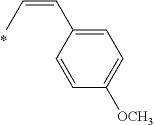 | 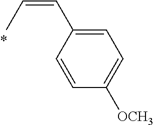 |
| B-(26) | OCH₃ | OCH₃ | 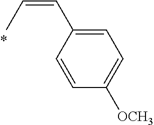 | 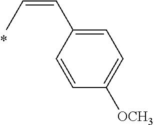 |
| B-(27) | 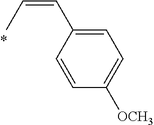 | 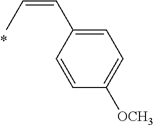 | H | H |
| B-(28) | 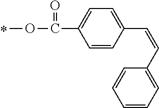 | 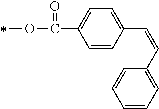 | H | H |

TABLE 5

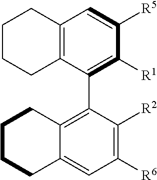

| | | | | |
|---|---|---|---|---|
| Table 5 | R¹ | R² | R⁵ | R⁶ |

| | | | |
|---|---|---|---|
| B-(29) | 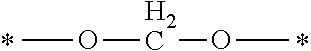 | 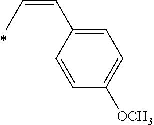 | H |
| B-(30) | 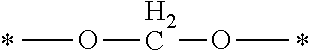 | 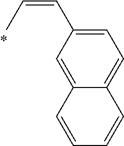 | 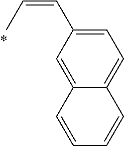 |
| B-(31) | 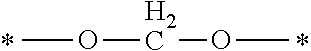 | 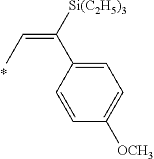 | 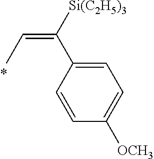 |
| B-(32) | 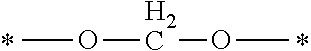 | 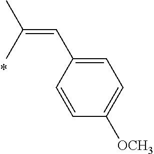 | 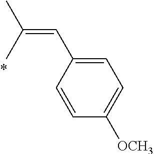 |
| B-(33) | 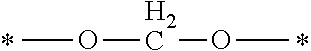 | 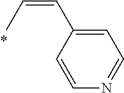 | 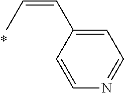 |
| B-(34) | 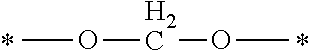 | 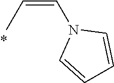 | 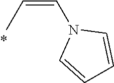 |

TABLE 6

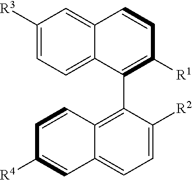

| Table 6 | R¹ | R² |
|---|---|---|
| B-(35) | 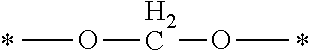 | |
| B-(36) | 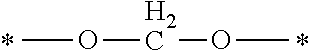 | |
| B-(37) | 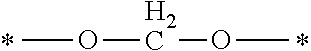 | |
| B-(38) | 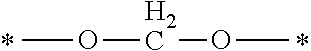 | |
| B-(39) | 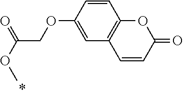 | 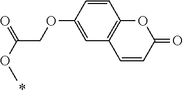 |
| B-(40) | 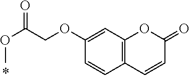 | 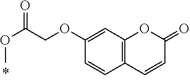 |
| B-(41) | 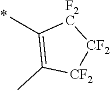 | *—CH₃ |
| B-(42) | 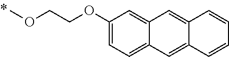 | 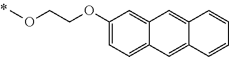 |
| B-(43) | 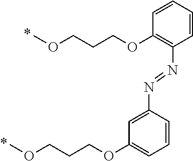 | |
| B-(44) | 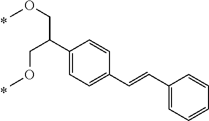 | |
| B-(45) | 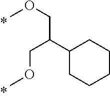 | |
| Table 6 | R³ | R⁴ |
| B-(35) | 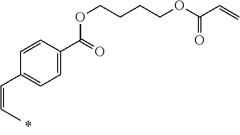 | 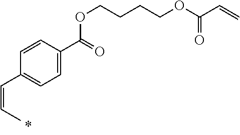 |
| B-(36) | 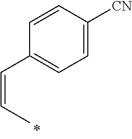 | 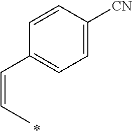 |
| B-(37) | 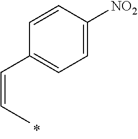 | 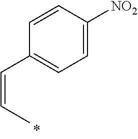 |
| B-(38) | 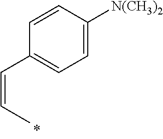 | 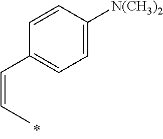 |
| B-(39) | H | H |
| B-(40) | H | H |
| B-(41) | H | H |
| B-(42) | H | H |
| B-(43) | H | H |
| B-(44) | H | H |
| B-(45) | 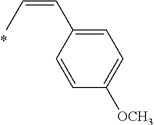 | 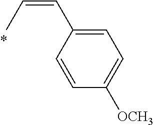 |

TABLE 7

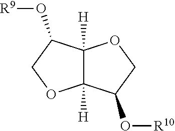

| Table 7 | R⁹ | R¹⁰ |
|---|---|---|
| B-(46) | 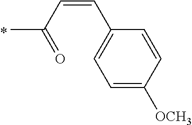 | 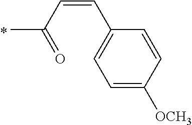 |
| B-(47) | 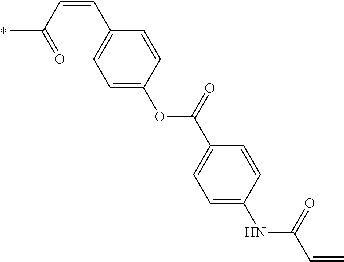 | 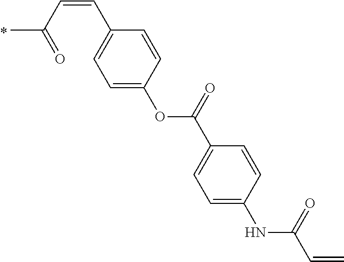 |

TABLE 8

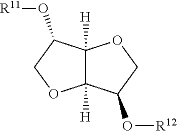

| Table 8 | R¹¹ | R¹² |
|---|---|---|
| B-(48) | 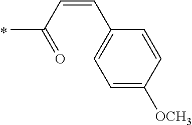 | 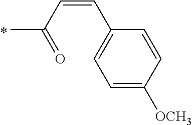 |
| B-(49) | 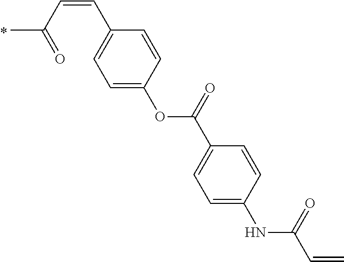 | 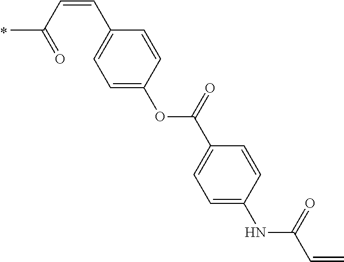 |

The HTP of the chiral agent A before light irradiation is, for example, preferably 10 to 100 μm⁻¹ and more preferably 50 to 100 μm⁻¹. In addition, the HTP of the chiral agent A after light irradiation is preferably 0 to 80 μm⁻¹ and more preferably 0 to 60 μm⁻¹.

The content of the chiral agent A in the liquid crystal composition is not specified and is preferably 0.5% to 10.0% by mass and more preferably 1.0% to 5.0% by mass with respect to the total mass of the liquid crystal compound, from the viewpoint that the liquid crystal compound is easily aligned uniformly.

The chiral agent A may be used alone or in combination of two or more thereof. In a case where two or more of the chiral agents A are used in combination, the total content thereof is preferably within the above range.

The HTP of the chiral agent B before light irradiation is, for example, preferably 0 to 30 μm⁻¹ and more preferably 0 to 20 μm⁻¹. In addition, the HTP of the chiral agent B after light irradiation is preferably 30 to 200 μm⁻¹, more preferably 35 to 200 μm⁻¹, still more preferably 40 to 200 μm⁻¹, and particularly preferably 50 to 200 μm⁻¹.

The content of the chiral agent B in the liquid crystal composition is not specified and is preferably 1.0% to 20.0% by mass and more preferably 2.0% to 10.0% by mass with respect to the total mass of the liquid crystal compound, from the viewpoint that the liquid crystal compound is easily aligned uniformly.

The chiral agent B may be used alone or in combination of two or more thereof. In a case where two or more of the chiral agents B are used in combination, the total content thereof is preferably within the above range.

The total content of the chiral agent in the liquid crystal composition according to the embodiment of the present invention (the total content of all chiral agents in the composition of the invention) is preferably 2.0% by mass or more and more preferably 3.0% by mass or more with respect to the total mass of the liquid crystal compound. In addition, from the viewpoint of suppressing the haze of the cholesteric liquid crystal layer, the upper limit of the total content of the chiral agent in the liquid crystal composition according to the embodiment of the present invention is preferably 18.0% by mass or less, more preferably 15.0% by mass or less, and still more preferably 12.0% by mass or less with respect to the total mass of the liquid crystal compound.

The content of each of the chiral agent A and the chiral agent B in the liquid crystal composition according to the embodiment of the present invention can be appropriately set according to the function (for example, high diffraction angle reflectivity or omnidirectional diffuse reflectivity) of the cholesteric liquid crystal layer to be formed. Since the helical pitch of the cholesteric liquid crystalline phase largely depends on the types of chiral agent A and chiral agent B and the addition concentration thereof, a desired pitch can be obtained by adjusting these factors.

<Polymerization Initiator>

The liquid crystal composition according to the embodiment of the present invention may contain a polymerization initiator. In particular, in a case where the liquid crystal compound has a polymerizable group, the liquid crystal composition according to the embodiment of the present invention preferably contains a polymerization initiator.

The polymerization initiator is preferably a photopolymerization initiator capable of initiating a polymerization reaction upon irradiation with ultraviolet rays. Examples of the photopolymerization initiator include α-carbonyl compounds (as described in U.S. Pat. Nos. 2,367,661A and 2,367,670A), acyloin ethers (as described in U.S. Pat. No. 2,448,828A), a-hydrocarbon-substituted aromatic acyloin compounds (as described in U.S. Pat. No. 2,722,512A), polynuclear quinone compounds (as described in U.S. Pat. Nos. 3,046,127A and 2,951,758A), combinations of triarylimidazole dimer and p-aminophenyl ketone (as described in U.S. Pat. No. 3,549,367A), acridine and phenazine compounds (as described in JP1985-105667A (JP-S60-105667A) and U.S. Pat. No. 4,239,850A), and oxadiazole compounds (as described in U.S. Pat. No. 4,212,970A).

The content of the polymerization initiator in the liquid crystal composition according to the embodiment of the present invention (the total amount of polymerization initiators in a case where a plurality of polymerization initiators are contained) is not particularly limited, and is preferably 0.1% to 20% by mass and more preferably 1.0% to 8.0% by mass with respect to the total mass of the liquid crystal compound.

<Surfactant>

The liquid crystal composition according to the embodiment of the present invention preferably contains a surfactant that can be unevenly distributed on the substrate-side surface of the composition layer and/or the surface of the composition layer opposite to the substrate.

The surfactant is not particularly limited, and examples thereof include a fluorine-based surfactant, a boronic acid compound, and an ionic surfactant. Above all, the liquid crystal composition according to the embodiment of the present invention preferably contains a fluorine-based surfactant.

The surfactants may be used alone or in combination of two or more thereof. The content of the surfactant in the liquid crystal composition according to the embodiment of the present invention (the total amount of surfactants in a case where a plurality of surfactants are contained) is not particularly limited, and is preferably 0.01% to 10% by mass, more preferably 0.01% to 5.0% by mass, and still more preferably 0.01% to 2.0% by mass with respect to the total mass of the liquid crystal compound.

<Solvent>

The liquid crystal composition according to the embodiment of the present invention may contain a solvent.

The solvent may be, for example, water or an organic solvent. Examples of the organic solvent include amides such as N,N-dimethylformamide; sulfoxides such as dimethylsulfoxide; heterocyclic compounds such as pyridine; hydrocarbons such as benzene and hexane; alkyl halides such as chloroform and dichloromethane; esters such as methyl acetate, butyl acetate, and propylene glycol monoethyl ether acetate; ketones such as acetone, methyl ethyl ketone, cyclohexanone, and cyclopentanone; ethers such as tetrahydrofuran and 1,2-dimethoxyethane; and 1,4-butanediol diacetate.

The solvents may be used alone or in combination of two or more thereof.

<Other Additives>

The liquid crystal composition according to the embodiment of the present invention may contain other additives such as an antioxidant, an ultraviolet absorber, a sensitizer, a stabilizer, a plasticizer, a chain transfer agent, a polymerization inhibitor, an antifoaming agent, a leveling agent, a thickener, a flame retardant, a dispersant, and a coloring material such as a dye or a pigment.

[Suitable Aspect of Liquid Crystal Composition]

In the liquid crystal composition according to the embodiment of the present invention, it is preferable that one or more of the compounds constituting the liquid crystal composition are compounds having a plurality of polymerizable groups (polyfunctional compounds). Further, the total content of the compounds having a plurality of polymerizable groups in the liquid crystal composition according to the embodiment of the present invention is preferably 80% by mass or more with respect to the total solid content in the liquid crystal composition according to the embodiment of the present invention. The solid content is a component that forms the cholesteric liquid crystal layer and does not include a solvent.

By making 80% by mass or more of the total solid content in the liquid crystal composition according to the embodiment of the present invention a compound having a plurality of polymerizable groups, it is preferable from the viewpoint that the structure of the cholesteric liquid crystalline phase can be firmly immobilized to impart the durability.

The compound having a plurality of polymerizable groups is a compound having two or more immobilizable groups in one molecule. In the present invention, the polyfunctional compound contained in the liquid crystal composition according to the embodiment of the present invention may or may not have liquid crystallinity.

[Cholesteric Liquid Crystal Layer and Method for Producing Same]

Next, the cholesteric liquid crystal layer formed of the liquid crystal composition according to the embodiment of the present invention will be described.

In the present specification, the “cholesteric liquid crystal layer” includes both a cholesteric liquid crystal layer in which a cholesteric liquid crystalline phase is immobilized by a curing treatment and a cholesteric liquid crystal layer in which a cholesteric liquid crystalline phase is not immobilized without a curing treatment, unless otherwise specified.

It is sufficient for the cholesteric liquid crystal layer according to the embodiment of the present invention that the optical properties of the cholesteric liquid crystalline phase are retained in the layer, and the liquid crystal compound in the layer may not exhibit liquid crystallinity.

In the following description of the cholesteric liquid crystal layer according to the embodiment of the present invention, a cholesteric liquid crystal layer having excellent high diffraction angle reflectivity and a method for producing the same will be described as a first embodiment, and a cholesteric liquid crystal layer capable of omnidirectional diffuse reflection and a method for producing the same will be described as a second embodiment.

[First Embodiment]

Hereinafter, a cholesteric liquid crystal layer according to the first embodiment will be described together with a method for producing the cholesteric liquid crystal layer.

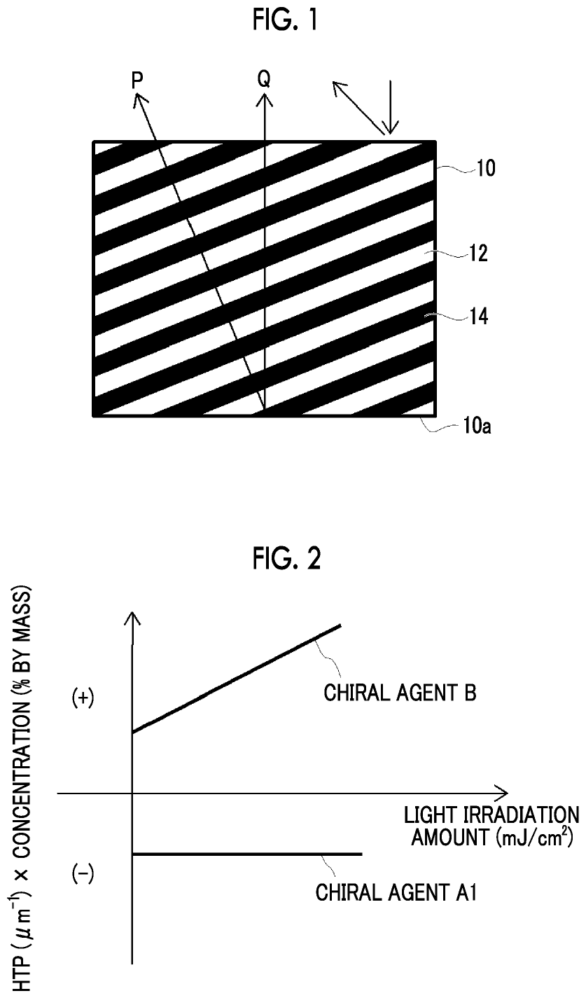

The cholesteric liquid crystal layer according to the first embodiment will be described with reference to FIG. 1.

In a case where a cross section perpendicular to a main surface 10a of a cholesteric liquid crystal layer 10 according to the first embodiment is observed by SEM, a stripe pattern is observed in which an arrangement direction P in which bright portions 12 and dark portions 14 are alternately arranged is tilted at a predetermined angle with respect to a normal line Q of the main surface 10a of the cholesteric liquid crystal layer 10. It should be noted that two repetitions of the bright portion 12 and the dark portion 14 in FIG. 1 correspond to one helical pitch (one helical turn). In the cholesteric liquid crystal layer 10, a surface substantially orthogonal to the arrangement direction P is a reflecting surface. That is, since the cholesteric liquid crystal layer 10 has high diffraction angle reflectivity, for example, in a case where light is incident on the cholesteric liquid crystal layer 10 from a normal direction, the light is reflected in an oblique direction at a predetermined angle different from the normal direction (see the arrow in FIG. 1).

Since a normal cholesteric liquid crystal layer (that is, a cholesteric liquid crystal layer is intended in which the arrangement direction of bright portions and dark portions derived from the cholesteric liquid crystalline phase is parallel to the normal line of the main surface of the cholesteric liquid crystal layer) is specular reflective, light is reflected in the normal direction of the cholesteric liquid crystal layer in a case where the light is incident from the normal direction of the cholesteric liquid crystal layer.

The angle (acute angle) formed with respect to the normal line Q of the main surface 10a of the cholesteric liquid crystal layer 10 in the arrangement direction P is preferably 10 to 90° and more preferably 15 to 90°.

The method for producing a cholesteric liquid crystal layer according to the first embodiment includes steps 1 to 3 in this order.

Step 1: a composition layer forming step of forming a composition layer using the liquid crystal composition according to the embodiment of the present invention.

Step 2: a liquid crystal layer forming step of aligning the liquid crystal compound contained in the composition layer into a liquid crystal phase.

Step 3: a light irradiating step of irradiating at least a partial region of the composition layer with light to increase the helical twisting power of the chiral agent B in the light-irradiated region.

In the method for producing a cholesteric liquid crystal layer according to the first embodiment, the liquid crystal phase in the step 2 is a nematic liquid crystal phase.

The step 3 is a step of irradiating the composition layer in an alignment state of the nematic liquid crystal phase obtained in the step 2 with light to increase the helical twisting power of the chiral agent B in the composition layer in the light-irradiated region to thereby bring the alignment state of the liquid crystal compound into a cholesteric liquid crystalline phase. In a case where the composition layer in an alignment state of the nematic liquid crystal phase is irradiated with light, the composition layer is aligned such that the molecular axis derived from the liquid crystal compound is tilted with respect to the normal line of the main surface of the composition layer, which then results in a state of a cholesteric liquid crystalline phase. In a case where the liquid crystal compound takes such an alignment, the cholesteric liquid crystal layer is obtained through the step 3 such that the helical axis derived from the cholesteric liquid crystalline phase is tilted with respect to the main surface of the cholesteric liquid crystal layer. In a case where a vertical cross section of the main surface of the cholesteric liquid crystal layer obtained through the step 3 is observed with a scanning electron microscope (SEM), a stripe pattern image is observed in which an arrangement direction in which bright portions and dark portions derived from the cholesteric liquid crystalline phase are alternately arranged is tilted with respect to the normal line of the main surface of the cholesteric liquid crystal layer (see FIG. 1). That is, as a result of the above, the reflecting surface of the cholesteric liquid crystal layer is tilted with respect to the main surface of the cholesteric liquid crystal layer.

In addition, in a case where the liquid crystal compound has a polymerizable group, the method for producing a cholesteric liquid crystal layer according to the first embodiment is preferably such that the composition layer is subjected to a curing treatment, as will be described later.

Next, the mechanism of action of the liquid crystal composition used in the method for producing a cholesteric liquid crystal layer according to the first embodiment and the procedure of each step will be described.

<Mechanism of Action of Liquid Crystal Composition Used in First Embodiment>

In a case where the cholesteric liquid crystal layer according to the first embodiment is formed using the liquid crystal composition according to the embodiment of the present invention, the step 3 is such that the composition layer whose alignment state is a nematic liquid crystal phase is subjected to a light irradiation treatment to increase the helical twisting power of the chiral agent B (and to decrease the helical twisting power of the chiral agent A in a case where the chiral agent A is a chiral agent whose helical twisting power decreases upon irradiation with light) in the composition layer in the light-irradiated region, which brings the alignment state of the liquid crystal compound in the composition layer into a cholesteric liquid crystalline phase.

Here, in a case where the alignment state of the liquid crystal compound in the composition layer is brought into a cholesteric liquid crystalline phase in the step 3, the helical twisting power that induces the helix of the liquid crystal compound is considered to roughly correspond to the weighted average helical twisting power of the chiral agents contained in the composition layer. The weighted average helical twisting power here is represented by Expression (1C), for example, in a case where two types of chiral agents (chiral agent A and chiral agent B) are used in combination.

Expression (1C): Weighted average helical twisting power (μm⁻¹)=(helical twisting power of chiral agent A (μm⁻¹)×concentration of chiral agent A with respect to liquid crystal compound (% by mass)+helical twisting power of chiral agent B) (μm⁻¹)×concentration of chiral agent B with respect to liquid crystal compound (% by mass))/(concentration of chiral agent A with respect to liquid crystal compound (% by mass)+concentration of chiral agent B in liquid crystal composition (% by mass)).

However, in Expression (1 C), in a case where the helical direction of the chiral agent is dextrorotatory, the helical twisting power has a positive value. In addition, in a case where the helical direction of the chiral agent is levorotatory, the helical twisting power has a negative value. That is, for example, in a case of a chiral agent having a helical twisting power of 10 μm⁻¹, the helical twisting power is expressed as 10 μm⁻¹ in a case where the helical direction of the helix induced by the chiral agent is right-handed. On the other hand, in a case where the helical direction of the helix induced by the chiral agent is left-handed, the helical twisting power is expressed as −10 μm⁻¹.

The weighted average helical twisting power (μm⁻¹) obtained by Expression (1C) can also be calculated from Expression (1A) and Expression (1B).

Hereinafter, the weighted average helical twisting power of the chiral agent A and the chiral agent B will be described with reference to specific aspects as an example.

First, the weighted average helical twisting power in a case where the composition layer contains the chiral agent Al and the chiral agent B having the following characteristics will be described as an example.

As shown in FIG. 2, the chiral agent A1 is a chiral agent having a left-handed (−) helical twisting power and whose helical twisting power does not change upon irradiation with light. In addition, as shown in FIG. 2, the chiral agent B is a chiral agent having a right-handed (+) helical twisting power, which is opposite in direction to that of the chiral agent A1, and whose helical twisting power increases upon irradiation with light. Here, “helical twisting power of chiral agent A1 (μm⁻¹)×concentration of chiral agent A1 (% by mass)” and “helical twisting power of chiral agent B (μm⁻¹)×concentration of chiral agent B (% by mass)” at the time of no light irradiation treatment are equal. In addition, in FIG. 2, with regard to the “helical twisting power of chiral agent (μm⁻¹) x concentration of chiral agent (% by mass)” on the vertical axis, the more the value thereof deviates from zero, the larger the helical twisting power becomes.

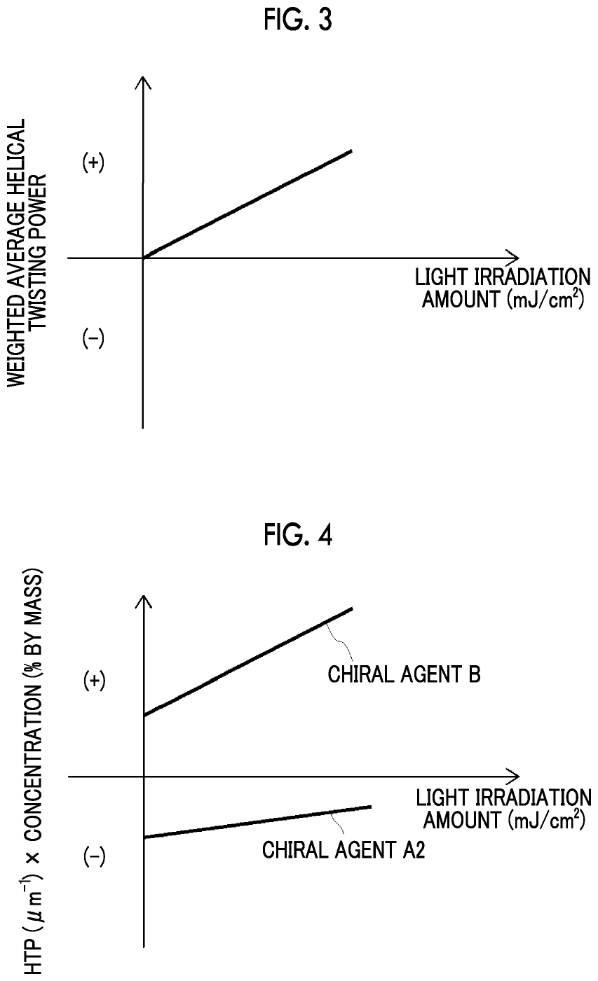

In a case where the composition layer contains the chiral agent A1 and the chiral agent B, the helical twisting power that induces the helix of the liquid crystal compound matches the weighted average helical twisting power of the chiral agent A1 and the chiral agent B. That is, as shown in FIG. 3, in a system in which the chiral agent A1 and the chiral agent B are used in combination, it is considered that the helical twisting power before light irradiation is zero, and the helical twisting power after light irradiation increases in the direction (+) of the helix induced by the chiral agent B.

Further, as another example, the weighted average helical twisting power in a case where the composition layer contains the chiral agent A2 and the chiral agent B having the following characteristics will be described.

As shown in FIG. 4, the chiral agent A2 is a chiral agent having a left-handed (−) helical twisting power and whose helical twisting power decreases upon irradiation with light. The “decrease in helical twisting power” as described above means a decrease in a case where an initial helical direction (before light irradiation) of each of the chiral agent A2 and the chiral agent B is set to “positive”. In addition, as shown in FIG. 4, the chiral agent B is a chiral agent having a right-handed (+) helical twisting power, which is opposite in direction to that of the chiral agent A2, and whose helical twisting power increases upon irradiation with light. Here, “helical twisting power of chiral agent A2 (μm⁻¹)×concentration of chiral agent A2 (% by mass)” and “helical twisting power of chiral agent B (μm⁻¹)×concentration of chiral agent B (% by mass)” at the time of no light irradiation are equal. In addition, in FIG. 4, with regard to the “helical twisting power of chiral agent (μm⁻¹)×concentration of chiral agent (% by mass)” on the vertical axis, the more the value thereof deviates from zero, the larger the helical twisting power becomes.

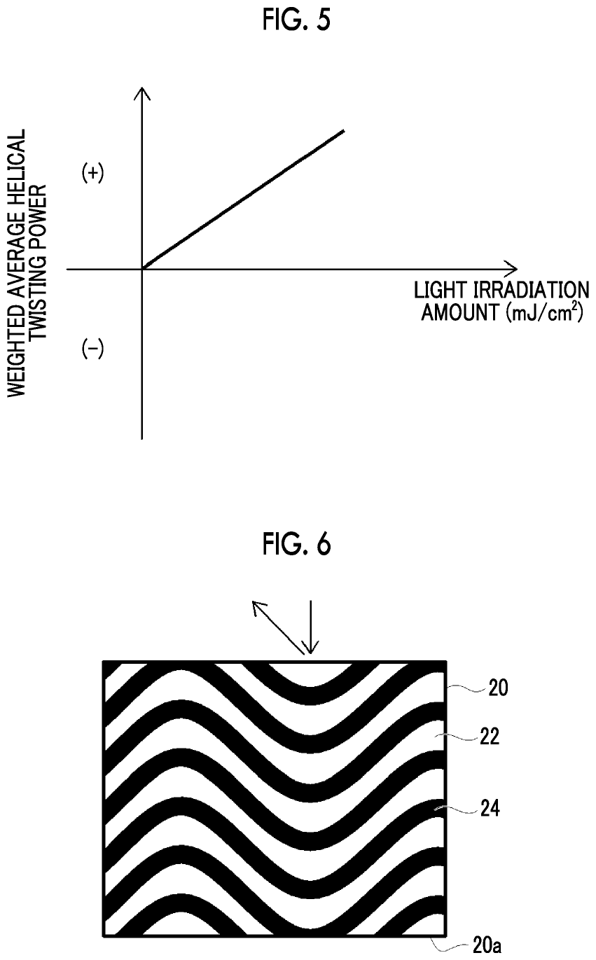

In a case where the composition layer contains the chiral agent A2 and the chiral agent B, the helical twisting power that induces the helix of the liquid crystal compound matches the weighted average helical twisting power of the chiral agent A2 and the chiral agent B. That is, as shown in FIG. 5, in a system in which the chiral agent A2 and the chiral agent B are used in combination, it is considered that the helical twisting power before light irradiation is zero, and the helical twisting power after light irradiation increases by the sum of an increment in the helical twisting power in a helical direction (+) induced by the chiral agent B and a decrement in the helical twisting power in a helical direction (−) induced by the chiral agent A (that is, it corresponds to an increment in the helical twisting power in a helical direction (+) of the chiral agent A). That is, the weighted average helical twisting power of the chiral agent A and the chiral agent B after light irradiation can be further increased as compared with the case where the chiral agent A is a chiral agent (A2) whose helical twisting power decreases upon irradiation with light, and the case where the chiral agent A is a chiral agent (A1) whose helical twisting power does not change upon irradiation with light.

In the method for producing a cholesteric liquid crystal layer according to the first embodiment, the liquid crystal compound in the composition layer is brought into a nematic alignment in the step 2. In order to bring the alignment state of the liquid crystal compound in the composition layer into a nematic liquid crystal phase in the step 2, the absolute value of the weighted average helical twisting power of the chiral agent in the composition layer in the step 2 is preferably 0.0 to 1.5 μm⁻¹, more preferably 0.0 to 1.0 μm⁻¹, still more preferably 0.0 to 0.5 μm⁻¹, and particularly preferably 0.0 μm⁻¹. On the other hand, in the light irradiation treatment of the step 3, the absolute value of the weighted average helical twisting power of the chiral agent in the composition layer is not particularly limited as long as the liquid crystal compound can be cholesterically aligned, and it is preferably 15.0 μm⁻¹ or more, more preferably 15.0 to 200.0 μm¹, and still more preferably 30.0 to 200.0 μm⁻¹. That is, the helical twisting power of the chiral agent in the composition layer is offset to substantially zero in the step 2, and therefore the liquid crystal compound in the composition layer can be aligned into a nematic liquid crystal phase. Next, the helical twisting power of the chiral agent B is increased (and the helical twisting power of the chiral agent A is decreased in a case where the chiral agent A is a chiral agent whose helical twisting power decreases upon irradiation with light), which is triggered by the light irradiation treatment in the step the 3, to increase the weighted average helical twisting power of the chiral agent in the composition layer in either a right-handed (+) direction or a left-handed (−) direction (corresponding to the helical direction induced by the chiral agent B), whereby the cholesteric liquid crystal layer according to the first embodiment can be formed.

Therefore, from the above viewpoint, the liquid crystal composition used in the first embodiment is preferably a liquid crystal composition that can form a nematic alignment in a case where the liquid crystal compound in the liquid crystal composition is aligned into a liquid crystal phase state.

Further, the absolute value of the weighted average helical twisting power of the chiral agent in the liquid crystal composition used in the first embodiment before light irradiation is preferably 0.0 to 1.5 μm⁻¹, more preferably 0.0 to 1.0 μm⁻¹, still more preferably 0.0 to 0.5 μm⁻¹, and particularly preferably 0.0 μm⁻¹.

In addition, the absolute value of the weighted average helical twisting power of the chiral agent in the liquid crystal composition used in the first embodiment after light irradiation is preferably 15.0 μm⁻¹ or more, more preferably 15.0 to 200.0 μm⁻¹, and still more preferably 30.0 to 200.0 μm⁻¹.

Hereinafter, specific procedures for each step of the method for producing a cholesteric liquid crystalline layer according to the first embodiment will be described.

<Step 1>

Specifically, the step I is preferably a step of bringing the liquid crystal composition according to the embodiment of the present invention into contact with a substrate to form a coating film on the substrate.

(Substrate)

The substrate is a plate that supports a composition layer formed from the liquid crystal composition according to the embodiment of the present invention. Among others, a transparent substrate is preferable. The transparent substrate is intended to refer to a substrate having a visible light transmittance of 60% or more and preferably has a visible light transmittance of 80% or more and more preferably 90% or more.

The material constituting the substrate is not particularly limited, and examples thereof include a cellulose-based polymer, a polycarbonate-based polymer, a polyester-based polymer, a (meth)acrylic polymer, a styrene-based polymer, a polyolefin-based polymer, a vinyl chloride-based polymer, an amide-based polymer, an imide-based polymer, a sulfone-based polymer, a polyether sulfone-based polymer, and a polyether ether ketone-based polymer.

The substrate may contain various additives such as an ultraviolet (UV) absorber, a matting agent fine particle, a plasticizer, a deterioration inhibitor, and a release agent.

In addition, the substrate preferably has low birefringence in the visible light region. For example, the phase difference at a wavelength of 550 nm of the substrate is preferably 50 nm or less and more preferably 20 nm or less.

The thickness of the substrate is not particularly limited, and is preferably 10 to 200 μm and more preferably 20 to 100 μm from the viewpoint of thinning and handleability.

The thickness is intended to refer to an average thickness, and is obtained by measuring thicknesses at any five places of the substrate and arithmetically averaging the measured values. Regarding the method of measuring the thickness, the same applies to the thickness of the cholesteric liquid crystal layer which will be described later.

In addition, in forming the cholesteric liquid crystal layer according to the first embodiment, it is preferable that the substrate has a rubbing alignment film having a pretilt angle or an alignment film containing a uniaxially aligned or hybrid-aligned liquid crystal compound on the surface of the substrate. By using the above substrate, the molecular axis derived from the liquid crystal compound is likely to be aligned so as to be tilted with respect to the normal line of the main surface of the composition layer, in a case where the cholesteric liquid crystalline phase in the step 3 is formed.

[Liquid Crystal Composition]

The liquid crystal composition used in the step 1 is as described above.

(Procedure of Step 1)

In the step 1, first, the liquid crystal composition according to the embodiment of the present invention is applied onto a substrate. The application method is not particularly limited, and examples thereof include a wire bar coating method, an extrusion coating method, a direct gravure coating method, a reverse gravure coating method, and a die-coating method. Prior to application of the liquid crystal composition according to the embodiment of the present invention, the substrate may be subjected to a known rubbing treatment.

In addition, if necessary, a treatment for drying the coating film applied onto the substrate may be carried out after application of the liquid crystal composition according to the embodiment of the present invention. The solvent can be removed from the coating film by carrying out the drying treatment.

The film thickness of the coating film is not particularly limited, and is preferably 0.1 to 20 μm, more preferably 0.2 to 15 μm, and still more preferably 0.5 to 10 μm from the viewpoint of more excellent reflection anisotropy and haze of the cholesteric liquid crystal layer.

<Step 2>

Specifically, the step 2 is a step of heating the composition layer obtained in the step 1 to bring the alignment state of the liquid crystal compound contained in the composition layer into a nematic liquid crystal phase.

The liquid crystal phase transition temperature of the liquid crystal composition according to the embodiment of the present invention is preferably in a range of 10° C. to 250° C. and more preferably in a range of 10° C. to 150° C., from the viewpoint of manufacturing suitability.

The heating temperature is preferably 40° C. to 100° C. and more preferably 60° C. to 100° C. In addition, the heating time is preferably 0.5 to 5 minutes and more preferably 0.5 to 2 minutes.

In a case of heating the composition layer, it is preferable not to heat the composition layer to a temperature at which the liquid crystal compound is in an isotropic phase (Iso). In a case where the composition layer is heated above the temperature at which the liquid crystal compound becomes an isotropic phase, defects in the nematic liquid crystal phase are increased, which is not preferable.

Further, as described above, in a case of producing the cholesteric liquid crystal layer according to the first embodiment, it is effective to give a pretilt angle to the interface, specific examples of which include the following methods.

(1) A substrate on which a rubbing alignment film having a pretilt angle or an alignment film containing a uniaxially aligned or hybrid-aligned liquid crystal compound is arranged on the surface is used.

(2) A surfactant (for example, the above-mentioned fluorine-based surfactant) that is unevenly distributed at the air interface and/or the substrate interface and can control the alignment of the liquid crystal compound is added to the liquid crystal composition according to the embodiment of the present invention.

(3) A liquid crystal compound having a large pretilt angle at the interface is added as the liquid crystal compound to the liquid crystal composition according to the embodiment of the present invention.

By giving a pretilt angle to the interface, the cholesteric liquid crystalline phase in the step 3 tends to be in a state in which the molecular axis derived from the liquid crystal compound in the vertical cross section of the main surface of the composition layer is aligned so as to be tilted with respect to the normal line of the main surface of the composition layer.

<Step 3>

The step 3 is a step of subjecting the composition layer obtained in the step 2 to a light irradiation treatment to increase the helical twisting power of the chiral agent B (and to decrease the helical twisting power of the chiral agent A in a case where the chiral agent A is a chiral agent whose helical twisting power decreases upon irradiation with light) in the light-irradiated region to thereby cholesterically align the liquid crystal compound in the composition layer into a cholesteric liquid crystalline phase.

Regions having different helical pitches (regions having different selective reflection wavelengths) can be further formed by dividing the light-irradiated region into a plurality of domains and adjusting a light irradiation amount for each domain.

The irradiation intensity of the light irradiation in the step 3 is not particularly limited and can be appropriately determined based on the helical twisting power of the chiral agent B. In general, the irradiation intensity of light irradiation in the step 3 is preferably about 0.1 to 200 mW/cm². In addition, the time for light irradiation is not particularly limited, and may be appropriately determined from the viewpoint of both sufficient strength and productivity of the layer to be obtained.

In addition, the temperature of the composition layer at the time of light irradiation is, for example, 0° C. to 100° C., and preferably 10° C. to 60° C.

The light used for the light irradiation is not particularly limited as long as it is an actinic ray or radiation that increases the helical twisting power of the chiral agent B (and decreases the helical twisting power of the chiral agent A in a case where the chiral agent A is a chiral agent whose helical twisting power decreases upon irradiation with light), which refers to, for example, an emission line spectrum of a mercury lamp, a far ultraviolet ray represented by an excimer laser, an extreme ultraviolet ray (EUV light), an X-ray, an ultraviolet ray, and an electron beam (EB). Of these, an ultraviolet ray is preferable.

In addition, the irradiation wavelength at the time of light irradiation is not particularly limited, and can be appropriately determined in consideration of the absorption wavelength, the isomerization wavelength, and the like of the chiral agent B (and the absorption wavelength, the isomerization wavelength, and the like of the chiral agent A in a case where the chiral agent A is a chiral agent whose helical twisting power decreases upon irradiation with light).

Here, in the method for producing a cholesteric liquid crystal layer according to the first embodiment, the surface state of the cholesteric liquid crystal layer to be formed may be uneven in a case where the composition layer is exposed to wind. Considering this point, in the method for producing a cholesteric liquid crystal layer according to the first embodiment, it is preferable that the wind speed of the environment to which the composition layer is exposed is low in all steps of the steps 1 to 3. Specifically, in the method for producing a cholesteric liquid crystal layer according to the first embodiment, the wind speed of the environment to which the composition layer is exposed is preferably 1 m/s or less in all steps of the steps 1 to 3.

It is also preferable to further have a step of heating the cholesteric liquid crystal layer obtained through the step 3 after the step 3 is carried out. The liquid crystal compound tends to form a more uniform cholesteric alignment state by carrying out the heat treatment after the step 3.

The heat treatment conditions are the same as those in the step 2 described above, and suitable aspects thereof are also the same.

<Curing Treatment>

In addition, in a case where the liquid crystal compound has a polymerizable group, it is preferable to carry out a curing treatment on the composition layer. Examples of the procedure for carrying out the curing treatment on the composition layer include the following (1) and (2).

There is further included a step 4 of (1) carrying out a curing treatment for immobilizing a cholesteric alignment state during the step 3 to form a cholesteric liquid crystal layer in which the cholesteric alignment state is immobilized (that is, the curing treatment is carried out simultaneously with the step 3), or

(

2) carrying out a curing treatment for immobilizing a cholesteric alignment state after the step 3 to form a cholesteric liquid crystal layer in which the cholesteric alignment state is immobilized.

That is, the cholesteric liquid crystal layer obtained by carrying out the curing treatment corresponds to a layer formed by immobilizing the cholesteric liquid crystalline phase.

Here, as the state where the cholesteric liquid crystalline phase is “immobilized”, the most typical and preferred aspect is a state in which the alignment of the liquid crystal compound brought into a cholesteric liquid crystalline phase is retained. The state where the liquid crystalline phase is “immobilized” is not limited thereto, and specifically, it refers to a state in which, in a temperature range of usually 0° C. to 50° C. and in a temperature range of −30° C. to 70° C. under more severe conditions, this layer has no fluidity and can keep a immobilized alignment form stably without causing changes in alignment form due to external field or external force. In the present invention, as will be described later, it is preferable to immobilize the alignment state of a cholesteric liquid crystalline phase by a curing reaction proceeding upon irradiation with ultraviolet rays.

In the layer obtained by immobilizing a cholesteric liquid crystalline phase, it is sufficient that the optical properties of the cholesteric liquid crystalline phase are retained in the layer, and finally the composition in the layer no longer needs to show liquid crystallinity.

The method of the curing treatment is not particularly limited, and examples thereof include a photo curing treatment and a thermal curing treatment. Above all, a light irradiation treatment is preferable, and an ultraviolet irradiation treatment is more preferable. In addition, as described above, the liquid crystal compound is preferably a liquid crystal compound having a polymerizable group. In a case where the liquid crystal compound has a polymerizable group, the curing treatment is preferably a polymerization reaction upon irradiation with light (particularly ultraviolet irradiation), and more preferably a radical polymerization reaction upon irradiation with light (particularly ultraviolet irradiation).

For ultraviolet irradiation, a light source such as an ultraviolet lamp is used. The irradiation energy amount of ultraviolet rays is not particularly limited, and is generally preferably about 100 to 800 mJ/cm². The irradiation time of the ultraviolet rays is not particularly limited, and may be determined as appropriate from the viewpoint of both sufficient strength and productivity of the obtained layer.

[Second Embodiment]

Hereinafter, a cholesteric liquid crystal layer according to the second embodiment will be described together with a method for producing the cholesteric liquid crystal layer.

The cholesteric liquid crystal layer according to the second embodiment will be described with reference to FIG. 6.

In a case where the cross section perpendicular to a main surface 20a of a cholesteric liquid crystal layer 20 according to the second embodiment is observed with a scanning electron microscope (SEM), a stripe pattern is observed in which bright portions 22 and dark portions 24 have a wave-like structure (undulated structure). It should be noted that two repetitions of the bright portion 22 and the dark portion 24 in FIG. 6 correspond to one helical pitch (one helical turn). In a case where light is incident on the cholesteric liquid crystal layer 20 having such a wave-like structure from the normal direction of the main surface 20a of the cholesteric liquid crystal layer 20, a part of the incidence ray is reflected at various angles in an oblique direction since there is a region where the helical axis of the liquid crystal compound is tilted, as shown in FIG. 6 (see the arrow in FIG. 6). In other words, the cholesteric liquid crystal layer 20 has omnidirectional diffuse reflectivity. That is, the cholesteric liquid crystal layer 20 has diffuse reflectivity in various angular directions due to the reflection directivity being suppressed.

Since a normal cholesteric liquid crystal layer (that is, a cholesteric liquid crystal layer is intended in which the bright portions and dark portions derived from the cholesteric liquid crystalline phase do not have a wave-like structure and are parallel to the main surface of the cholesteric liquid crystal layer) is specular reflective, light is reflected in the normal direction of the cholesteric liquid crystal layer in a case where the light is incident from the normal direction of the cholesteric liquid crystal layer.

The method for producing a cholesteric liquid crystal layer according to the second embodiment includes steps 1 to 3 in this order.

Step 1: a composition layer forming step of forming a composition layer using the liquid crystal composition according to the embodiment of the present invention.

Step 2: a liquid crystal layer forming step of aligning the liquid crystal compound contained in the composition layer into a liquid crystal phase.

Step 3: a light irradiating step of irradiating at least a partial region of the composition layer with light to increase the helical twisting power of the chiral agent B in the light-irradiated region.

In the method for producing a cholesteric liquid crystal layer according to the second embodiment, the liquid crystal phase in the step 2 is a cholesteric liquid crystalline phase.

The step 3 is a step of irradiating the composition layer in an alignment state of the cholesteric liquid crystalline phase obtained in the step 2 with light to increase the helical twisting power of the chiral agent B in the composition layer in the light-irradiated region to reduce the helical pitch of cholesteric liquid crystalline phase.

In a case where a vertical cross section of the main surface of the cholesteric liquid crystal layer obtained through the step 3 is observed with a scanning electron microscope (SEM), a stripe pattern image is observed in which bright portions and dark portions derived from the cholesteric liquid crystalline phase observed by SEM in a cross section perpendicular to the main surface of the cholesteric liquid crystal layer are wave-like (see FIG. 6). In a case where the composition having an alignment state of the cholesteric liquid crystalline phase in the step 2 is irradiated with light, it is considered that the twist of the liquid crystal compound in the light-irradiated region is further increased and as a result, the alignment (tilt of helical axis) of the cholesteric liquid crystalline phase is changed into the above-mentioned form.

The reduction of the helical pitch of the cholesteric liquid crystalline phase is intended to mean that a reduction rate Z represented by Expression (1X) is larger than zero, in a case where the central reflection wavelength of the cholesteric liquid crystalline phase before irradiation of the composition layer with light is X (nm), and the central reflection wavelength of the cholesteric liquid crystalline phase after irradiation of the composition layer with light is Y (nm).

$$Reduction rate Z ( \% ) = \{ \frac{( X - Y )}{X} \} \times 100 \qquad Expression ( 1 X )$$

The reduction rate Z of the helical pitch of the cholesteric liquid crystalline phase is preferably 5% or more, more preferably 10% or more, and still more preferably 20% or more, from the viewpoint that omnidirectional diffuse reflectivity occurs more significantly. The upper limit of the reduction rate Z is not particularly limited, and is often 50% or less.

In addition, in a case where the liquid crystal compound has a polymerizable group, the method for producing a cholesteric liquid crystal layer according to the second embodiment is preferably such that the composition layer is subjected to a curing treatment, as will be described later.

Next, the mechanism of action of the liquid crystal composition used in the method for producing a cholesteric liquid crystal layer according to the second embodiment and the procedure of each step will be described.

<Mechanism of Action of Liquid Crystal Composition Used in Second Embodiment>

In a case where the cholesteric liquid crystal layer according to the second embodiment is formed using the liquid crystal composition according to the embodiment of the present invention, the composition layer whose alignment state is a cholesteric liquid crystalline phase obtained in the step 2 is subjected to a light irradiation treatment in the step 3. In a case where the helical twisting power of the chiral agent B in the composition layer is increased (and the helical twisting power of the chiral agent A is decreased in a case where the chiral agent A is a chiral agent whose helical twisting power decreases upon irradiation with light) in this light-irradiated region, the twist of the liquid crystal compound in the composition layer becomes stronger and therefore a cholesteric liquid crystalline phase having a wave-like structure is formed.

The alignment state of the liquid crystal compound in the composition layer obtained in the step 2 is a cholesteric liquid crystalline phase in the method for producing a cholesteric liquid crystal layer according to the second embodiment, unlike the method for producing a cholesteric liquid crystal layer according to the first embodiment. It is considered that the helical twisting power inducing the helix of the liquid crystal compound in the step 2 generally corresponds to the weighted average helical twisting power of the chiral agent contained in the composition layer. The weighted average helical twisting power referred to here is as described hereinbefore.

In the method for producing a cholesteric liquid crystal layer according to the second embodiment, the absolute value of the weighted average helical twisting power of the chiral agent in the composition layer of the step 2 is preferably 1.6 μm⁻¹ or more and more preferably 2.0 μm⁻¹ or more. The upper limit value thereof is not particularly limited and is, for example, preferably 200 μm⁻¹ or less. On the other hand, the absolute value of the weighted average helical twisting power of the chiral agent in the composition layer after the light irradiation treatment in the step 3 is not particularly limited as long as the helical pitch of the cholesteric liquid crystalline phase formed in the step 2 can be reduced, and is preferably 20.0 μm⁻¹ or more, more preferably 20.0 to 200.0 μm⁻¹, and still more preferably 30.0 to 200.0 μm⁻¹.

The helical direction of the cholesteric liquid crystalline phase in the step 2 is preferably the same as the helical direction induced by the chiral agent B. That is, the liquid crystal compound in the composition layer obtained in the step 2 is preferably cholesterically aligned in a direction of the helix induced by the chiral agent B.

In a case where the step 2 has the above configuration, the cholesteric liquid crystal layer according to the second embodiment can be formed in such a manner that the liquid crystal compound is cholesterically aligned in the step 2 in a direction of the helix induced by the chiral agent B, and the helical twisting power of the chiral agent B is increased (and the helical twisting power of the chiral agent A is decreased in a case where the chiral agent A is a chiral agent whose helical twisting power decreases upon irradiation with light) in the light-irradiated region by the tight irradiation treatment of the step 3 to further increase the weighted average helical twisting power of the chiral agent in the composition layer in a direction of the helix induced by the chiral agent B.

In addition, the increase ratio of the weighted average helical twisting power of the chiral agent in the composition layer before and after light irradiation ((absolute value of weighted average helical twisting power of chiral agent in composition layer after light irradiation treatment in step 3—absolute value of weighted average helical twisting power of chiral agent in composition layer before light irradiation treatment in step 2)/absolute value of weighted average helical twisting power of chiral agent in composition layer before light irradiation treatment in step 2) is not particularly limited, and is preferably 5.0 or more. The upper limit value thereof is not particularly limited, and is preferably 20.0 or less.

Therefore, from the above viewpoint, the liquid crystal composition used in the second embodiment is preferably a liquid crystal composition that can form a cholesteric alignment in a case where the liquid crystal compound in the liquid crystal composition is aligned into a liquid crystal phase state.

Further, the liquid crystal composition used in the second embodiment preferably satisfies Expression (ID).

helical twisting power of chiral agent A [μm⁻¹]×content of chiral agent A with respect to liquid crystal compound [% by mass]<helical twisting power of chiral agent B [μm⁻¹]×content of chiral agent B with respect to liquid crystal compound [% by mass] Expression (1D)

Further, the absolute value of the weighted average helical twisting power of the chiral agent in the liquid crystal composition used in the second embodiment before light irradiation is preferably 1.6 μm⁻¹ or more and more preferably 2.0 μm⁻¹ or more. The upper limit value thereof is not particularly limited and is, for example, preferably 200 μm⁻¹ or less.

Further, the absolute value of the weighted average helical twisting power of the chiral agent in the liquid crystal composition used in the second embodiment after light irradiation is preferably 20.0 μm ⁻¹ or more, more preferably 20.0 to 200.0 μm⁻¹, and still more preferably 30.0 to 200.0 μm⁻¹.

In addition, the increase ratio of the weighted average helical twisting power of the chiral agent in the liquid crystal composition used in the second embodiment after light irradiation ((absolute value of weighted average helical twisting power of chiral agent after light irradiation - absolute value of weighted average helical twisting power of chiral agent before light irradiation)/absolute value of weighted average helical twisting power of chiral agent before light irradiation) is not particularly limited, and is preferably 5.0 or more. The upper limit value thereof is not particularly limited, and is preferably 20.0 or less.

Hereinafter, specific procedures for each step of the method for producing a cholesteric liquid crystalline layer according to the second embodiment will be described.

<Step 1>

The step 1 of the second embodiment has the same definition as the step 1 of the first embodiment, and a preferred embodiment thereof is also the same.

<Step 2>

Specifically, the step 2 is a step of heating the composition layer obtained in the step 1 to bring the alignment state of the liquid crystal compound contained in the composition layer into a cholesteric liquid crystalline phase.

The liquid crystal phase transition temperature of the liquid crystal composition according to the embodiment of the present invention is preferably in a range of 10° C. to 250° C. and more preferably in a range of 10° C. to 150° C., from the viewpoint of manufacturing suitability.

The heating temperature is preferably 40° C. to 100° C. and more preferably 60° C. to 100° C. In addition, the heating time is preferably 0.5 to 5 minutes and more preferably 0.5 to 2 minutes.

In a case of heating the composition layer, it is preferable not to heat the composition layer to a temperature at which the liquid crystal compound is in an isotropic phase (Iso). In a case where the composition layer is heated above the temperature at which the liquid crystal compound becomes an isotropic phase, defects in the cholesteric liquid crystalline phase are increased, which is not preferable.

<Step 3>

The step 3 is a step of irradiating at least a partial region of the composition layer with light to increase the helical twisting power of the chiral agent B contained in the composition layer in the light-irradiated region to thereby reduce the helical pitch.

The light-irradiated region may be an entire region or a partial region of the composition layer. In a case where the light-irradiated region is a partial region, a cholesteric liquid crystal layer having regions having different helical pitches (in other words, regions having different selective reflection wavelengths) can be formed in the plane. In addition, among the light-irradiated regions, regions having different helical pitches can be further formed by adjusting the light irradiation amount.

The irradiation intensity of light irradiation in the step 3 is not particularly limited, and is generally preferably about 0.1 to 200 mW/cm². In addition, the time for light irradiation is not particularly limited, and may be appropriately determined from the viewpoint of both sufficient strength and productivity of the layer to be obtained.

In addition, the temperature of the composition layer at the time of light irradiation is, for example, preferably 0° C. to 100° C. and more preferably 10° C. to 60° C.

The light used for the light irradiation is not particularly limited as long as it is an actinic ray or radiation that increases the helical twisting power of the chiral agent B, which refers to, for example, an emission line spectrum of a mercury lamp, a far ultraviolet ray represented by an excimer laser, an extreme ultraviolet ray (EUV light), an X-ray, an ultraviolet ray, and an electron beam (EB). Of these, an ultraviolet ray is preferable.

In addition, the irradiation wavelength at the time of light irradiation is not particularly limited, and can be appropriately determined in consideration of the absorption wavelength, the isomerization wavelength, and the like of the chiral agent B (and the absorption wavelength, the isomerization wavelength, and the like of the chiral agent A in a case where the chiral agent A is a chiral agent whose helical twisting power decreases upon irradiation with light).

It is also preferable to further have a step of heating the cholesteric liquid crystal layer that has undergone the step 3, after the step 3 is carried out. The liquid crystal compound tends to form a more uniform cholesteric alignment state by carrying out the heat treatment after the step 3.

The heat treatment conditions are the same as those in the step 2 described above, and suitable aspects thereof are also the same.

<Curing Treatment>

In addition, in a case where the liquid crystal compound has a polymerizable group, it is preferable to carry out a curing treatment on the composition layer. The procedure for carrying out the curing treatment on the composition layer is the same as the method for producing a cholesteric liquid crystal layer according to the first embodiment.

[Use]

The cholesteric liquid crystal layer is a layer showing selective reflection properties with respect to light in a predetermined wavelength range. The cholesteric liquid crystal layer functions as a circularly polarized light selective reflective layer that selectively reflects either dextrorotatory circularly polarized light or levorotatory circularly polarized light in a selective reflection wavelength range and transmits circularly polarized light of the other sense. A film containing one or two or more cholesteric liquid crystal layers can be used for various purposes. In a film containing two or more layers of a cholesteric liquid crystal layer, the senses of circularly polarized light reflected by the cholesteric liquid crystal layers may be the same or opposite to each other depending on the application. In addition, the central wavelengths of selective reflection of the cholesteric liquid crystal layers, which will be described later, may be the same as or different from each other depending on the application.

In the present specification, the term “sense” for circularly polarized light means dextrorotatory circularly polarized light or levorotatory circularly polarized light. The sense of circularly polarized light is defined such that the sense is dextrorotatory circularly polarized light in a case where a leading end of an electric field vector turns clockwise as time increases in a case where light is viewed as it travels toward an observer, and the sense is levorotatory circularly polarized light in a case where the leading end of an electric field vector turns counterclockwise. In the present specification, the term “sense” may be used for the twisted direction of the helix of the cholesteric liquid crystal. Selective reflection by the cholesteric liquid crystal reflects dextrorotatory circularly polarized light and transmits levorotatory circularly polarized light in a case where the twisted direction (sense) of the helix of the cholesteric liquid crystal is right-handed, whereas it reflects levorotatory circularly polarized light and transmits dextrorotatory circularly polarized light in a case where the sense is left-handed.

For example, a film containing a cholesteric liquid crystal layer exhibiting selective reflection properties in the visible light wavelength range (wavelength of 400 to 750 nm) can be used as a screen for projected image display and a half mirror. In addition, by controlling the reflection wavelength range, such a film can be used as a filter that improves the color purity of display light of a color filter or a display (for example, see JP2003-294948A).

In addition, the cholesteric liquid crystal layer can be used for various applications such as a polarizer, a reflective film (reflective layer), an antireflection film, a view angle compensation film, a holography, a security, a sensor, a real image projection mirror (front projection, rear projection), a mirror for virtual image projection, a decorative sheet, a heat shield sheet, a light shield sheet, and an alignment film, which are constituent elements of optical elements.

In addition, the cholesteric liquid crystal layer can also be used as a linearly polarized light reflecting member by combining the cholesteric liquid crystal layer with a phase difference plate or a polarizing plate.

Hereinafter, the application as a projected image display member which is a particularly preferred application will be described.

By the above-mentioned function of the cholesteric liquid crystal layer, a projected image can be formed by reflecting circularly polarized light of either sense at the wavelength showing selective reflection among the projected light. The projected image may be visually recognized as such by being displayed on the surface of the projected image display member or may be a virtual image which appears to float above the projected image display member as viewed from an observer.

The central wavelength λ of the selective reflection depends on the pitch P of the helical structure (=the period of the helix) in a cholesteric liquid crystalline phase and follows the relationship of λ=n×P where n is an average refractive index of the cholesteric liquid crystal layer. Here, the central wavelength λ of the selective reflection of the cholesteric liquid crystal layer means a wavelength at the centroid position of the reflection peak of a circularly polarized light reflection spectrum measured from the normal direction of the cholesteric liquid crystal layer. As can be seen from the above Expression, the central wavelength of the selective reflection can be adjusted by adjusting the pitch of the helical structure. Since the pitch of the cholesteric liquid crystalline phase depends on the type of the chiral agent or the addition concentration thereof, a desired pitch can be obtained by adjusting these factors. As a method for measuring sense or pitch of helix, methods described in “Easy Steps in Liquid Crystal Chemistry Experiment” p 46, edited by The Japanese Liquid Crystal Society, Sigma Publishing Company, 2007, and “Liquid Crystal Handbook” p 196, Editorial Committee of Liquid Crystal Handbook, Maruzen Co., Ltd. can be used.

In addition, a projected image display member capable of displaying full color projected images can be produced by preparing and laminating cholesteric liquid crystal layers having an apparent central wavelength of selective reflection in a red light wavelength range, a green light wavelength range, and a blue light wavelength range, respectively.

A clear projected image can be displayed with high efficiency of light utilization by adjusting the central wavelength of selective reflection of each cholesteric liquid crystal layer according to the emission wavelength range of a light source used for projection and the mode of use of a projected image display member. In particular, a clear color projected image can be displayed with high efficiency of light utilization by adjusting the central wavelength of selective reflection of each of the cholesteric liquid crystal layers according to the light emission wavelength range of the light source used for projection.

In addition, for example, in a case where the projected image display member is configured to be transmissive to light in the visible light region, a half mirror that can be used as a combiner for a head-up display can be obtained. The projected image display half mirror can display the image projected from the projector so as to be visible, and in a case where the projected image display half mirror is observed from the same surface side where the image is displayed, the information or scenery on the opposite surface side can be observed at the same time.

The cured substance obtained by curing the liquid crystal composition according to the embodiment of the present invention can be applied to various uses such as a coloring agent and a sensor.

In addition, the liquid crystal composition according to the embodiment of the present invention makes it possible to form an optically anisotropic body. In addition, the optically anisotropic body is intended to refer to a substance which has optical anisotropy.

In addition, the cholesteric liquid crystal layer according to the embodiment of the present invention can be applied to various uses as an optically anisotropic body. Examples

[Chiral Agent and Evaluation of Performance Thereof]

In the following, first, the chiral agent A and the chiral agent B will be described.

[Chiral agent A]

The structures of the chiral agents A (A-1 to A-5) shown in Table 9 to Table 11 are shown below.

Synthetic chiral agents were used as the chiral agents A-1 to A-5. The chiral agents A-1 to A-5 were synthesized by a general synthesis technique such as esterification.

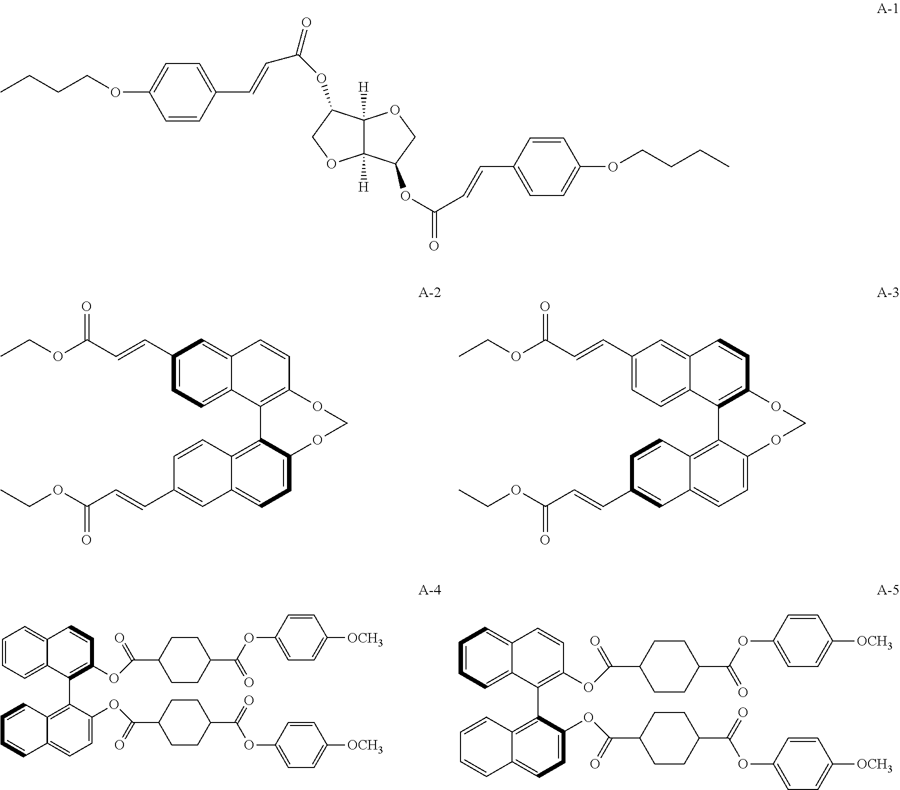

[Chiral Agent B]

The structures of the chiral agents B (B-1 to B-9) shown in Table 9 to Table 11 are shown below.

Synthetic chiral agents were used as the chiral agents B-1 to 13-9. The chiral agents B-1 to B-6, B-8 and B-9 were synthesized according to the method for synthesizing the chiral agent B-1 (Synthesis Example 1) which will be described later. The chiral agent B-7 was synthesized by general synthesis techniques such as etherification and esterification.

No temperature dependence was observed for any of the chiral agents B-1 to B-9, and an increase in UTP due to temperature changes was not observed.

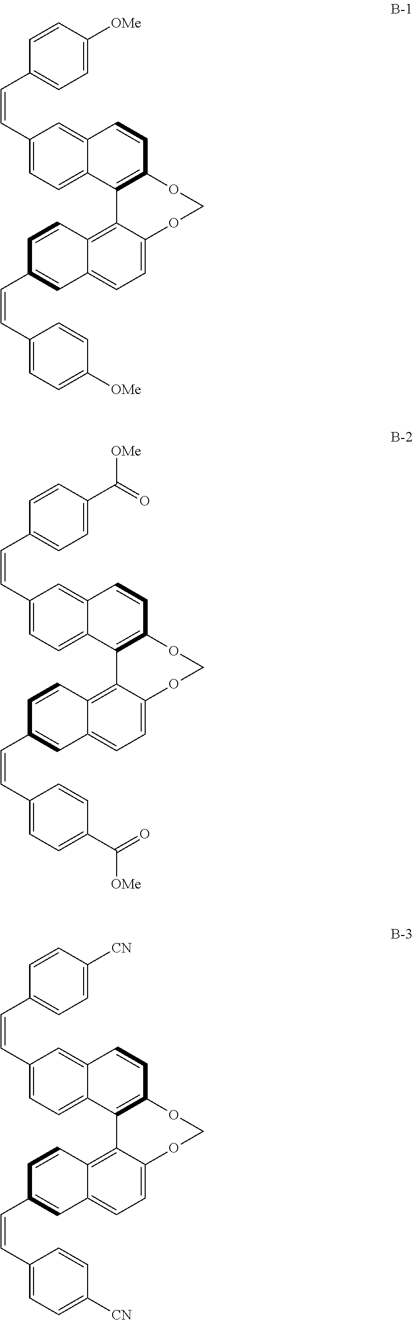

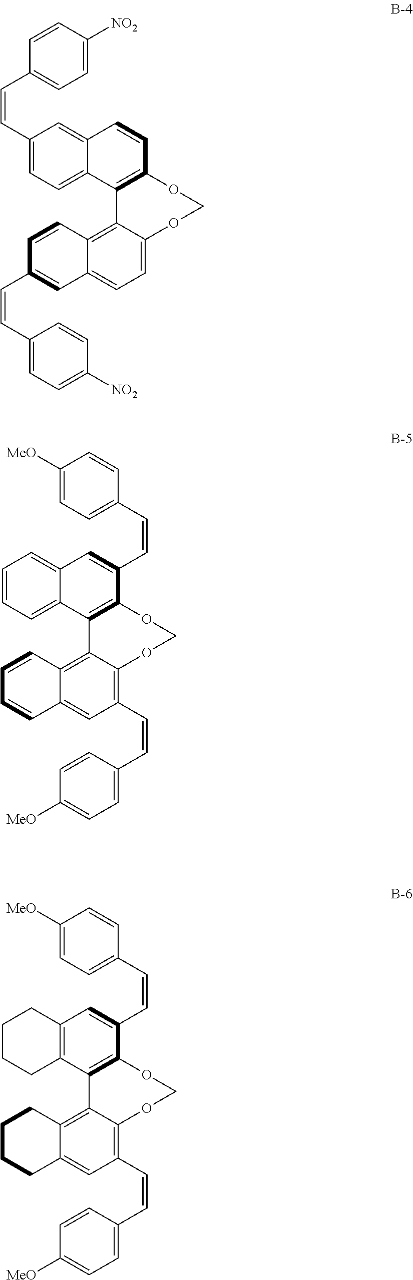

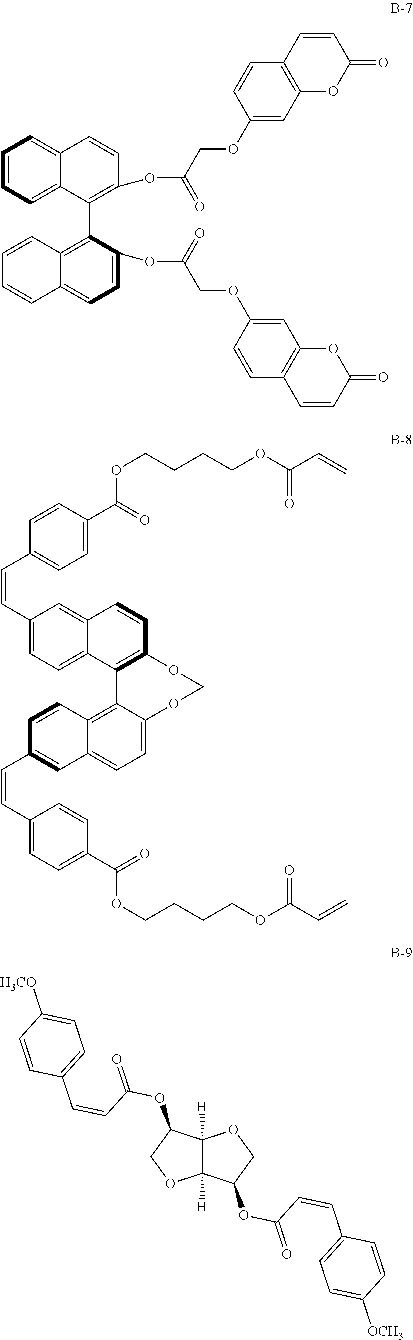

[Synthesis Example 1 (Synthesis of Compound B-1)]

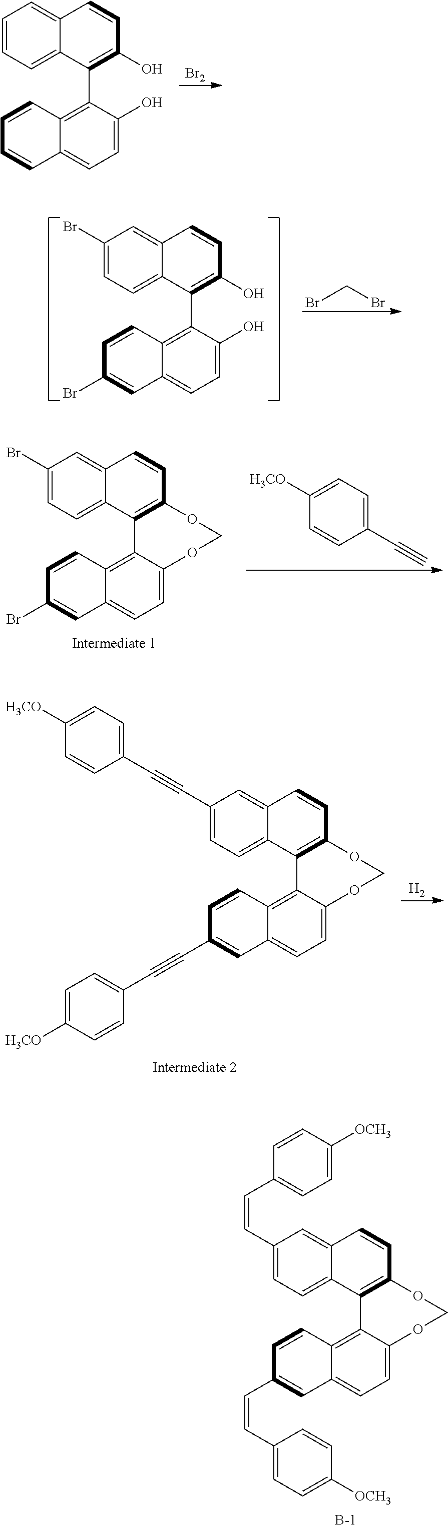

<Synthesis of Intermediate 1>

65.0 g of (R)-binaphthol (manufactured by Kanto Chemical Co., Inc.) and 500 mL of butyl acetate (manufactured by FUJIFILM Wako Pure Chemical Corporation) were placed in a 2 L three-neck flask to which 100 g of bromine (manufactured by FUJIFILM Wako Pure Chemical Corporation) was then added dropwise at 0° C., followed by stirring for 5 hours. Subsequently, the obtained reaction solution was washed with aqueous sodium hydrogen sulfite (21.7 g of sodium hydrogen sulfite (manufactured by FUJIFILM Wako Pure Chemical Corporation), 290 mL of water), 325 mL of water, and aqueous sodium hydrogen carbonate (13.0 g of sodium hydrogen carbonate (manufactured by FUJIFILM Wako Pure Chemical Corporation), 300 mL of water) in this order. The washed solution was dried over magnesium sulfate, the solvent was distilled off under reduced pressure, and the resulting residue was transferred to a three-neck flask.

Subsequently, 80.2 g of N,N-dimethylformamide (DMF, manufactured by FUJIFILM Wako Pure Chemical Corporation), 78.0 g of potassium carbonate (manufactured by FUJIFILM Wako Pure Chemical Corporation), 75.0 g of butyl acetate (manufactured by FUJIFILM Wako Pure Chemical Corporation), and 43.5 g of dibromomethane (manufactured by FUJIFILM Wako Pure Chemical Corporation) were added to the three-neck flask which was then stirred at 90° C. for 4 hours. The obtained reaction solution was cooled to room temperature, and then the solid was filtered off. 170 mL of ethyl acetate (manufactured by FUJIFILM Wako Pure Chemical Corporation) and 550 mL of methanol (manufactured by FUJIFILM Wako Pure Chemical Corporation) were added to the solution after filtering the solid, and the resulting solid was collected by filtration. Then, the obtained solid was blast-dried at 40° C. for 12 hours to obtain Intermediate 1 (66.0 g, yield: 75%).

<Synthesis of Intermediate 2>

20.0 g of Intermediate 1, 17.4 g of ethynyl anisole (manufactured by Tokyo Chemical Industry Co., Ltd.), 0.08 g of copper iodide (manufactured by FUJIFILM Wako Pure Chemical Corporation), 0.22 g of triphenylphosphine palladium dichloride (manufactured by Tokyo Chemical Industry Co., Ltd.), 120 mL of triethylamine (manufactured by FUJIFILM Wako Pure Chemical Corporation), and 40 mL of pyridine (manufactured by FUJIFILM Wako Pure Chemical Corporation) were placed in a 500 mL three-neck flask which was then stirred at 90° C. for 3 hours. Subsequently, the obtained reaction solution was cooled to 0° C., 400 mL of methanol (manufactured by FUJIFILM Wako Pure Chemical Corporation) was added, and the resulting solid was collected by filtration. Then, the obtained solid was blast-dried at 40° C. for 12 hours to obtain Intermediate 2 (22.0 g, yield: 90%).

<Synthesis of Compound B-1>

20.0 g of Intermediate 2, 10.0 g of Lindlar catalyst (manufactured by Tokyo Chemical Industry Co., Ltd.), 9.2 g of quinoline (manufactured by FUJIFILM Wako Pure Chemical Corporation), and 100 mL of 1,4-dioxane (manufactured by FUJIFILM Wako Pure Chemical Corporation) were placed in a 300 mL three-neck flask which was then purged with hydrogen and stirred at 80° C. for 6 hours. The solid was filtered off by Celite filtration, and the obtained solution was purified by column chromatography and then blast-dried at 40° C. for 12 hours to obtain Compound B-1 (18.0 g, yield: 90%).

[Evaluation of Helical Twisting Power (HTP) before and After Light Irradiation and Helical Sense Before and After Light Irradiation of Chiral Agent A and Chiral Agent B]

The helical twisting power (HTP) before and after light irradiation and the helical sense before and after light irradiation of the chiral agents A-1 to A-5 and the chiral agents B-1 to B-9 were evaluated by the following methods.

Hereinafter, methods for evaluating the helical twisting power (HIP) before and after light irradiation and the helical sense before and after light irradiation will be described by taking the chiral agent A-1 as an example. In these evaluations, a liquid crystal compound LC-1 which will be described later was used.

<Preparation of Sample Solution>

The liquid crystal compound LC-1 represented by the following structure and the chiral agent A-1 were mixed. Then, a solvent was added to the obtained mixture to prepare a sample solution having the following composition.

| | |
|---|---|
| Liquid crystal compound LC-1 represented | 100 parts by mass |
| by the following structure | |
| Chiral agent A-1 | 5 parts by mass |
| Solvent (methyl ethyl ketone (MEK)/ | added to make a solute concentration |
| cyclohexanone = 90/10 (mass ratio)) | of 30% by mass |

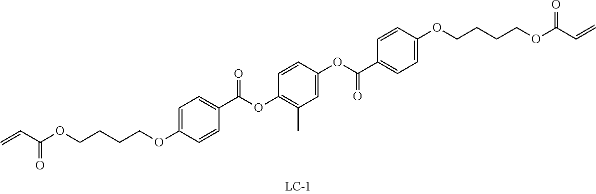 [SMILES: C=CC(=O)OCCCCOc1ccc(C(=O)Oc2ccc(OC(=O)c3ccc(OCCCCOC(=O)C=C)cc3)c(C)c2)cc1]

<Preparation of Liquid Crystal Layer 1-1>

Next, a composition for forming a polyimide alignment film SE-130 (manufactured by Nissan Chemical Corporation) was applied onto a washed glass substrate to form a coating film. The obtained coating film was baked and then subjected to a rubbing treatment to prepare a substrate with an alignment film. 30 μL of the sample solution was spin-coated on the rubbing-treated surface of this alignment film under the conditions of a rotation speed of 1000 rpm for 10 seconds, followed by aging at 90° C. for 1 minute to form a liquid crystal layer.

<Calculation of HTP>

«Evaluation of HTP Before Light Irradiation»

The helical twisting power (HTP) of the obtained liquid crystal layer was measured. Specifically, the central reflection wavelength of the liquid crystal layer was measured using a spectrophotometer (UV-3100, manufactured by Shimadzu Corporation), and the HTP before light irradiation was calculated by Expression (1B).

HTP=(average refractive index of liquid crystal compound)/{(content of chiral agent with respect to liquid crystal compound (% by mass))×(central reflection wavelength (nm))} [μm⁻¹] Expression (1B)

In Expression (1B), the HTP was calculated on the assumption that the “average refractive index of liquid crystal compound” was 1.55.

«Evaluation of HTP After Light Irradiation»

Next, the liquid crystal layer was UV-irradiated with mercury lamp light through a 315 nm bandpass filter at an irradiation intensity of 30 mW/cm² for 3.3 seconds. The central reflection wavelength of the liquid crystal layer after light irradiation was measured using a spectrophotometer (UV-3100, manufactured by Shimadzu Corporation), and the HTP after light irradiation was calculated by Expression (1B).

<Examination of Helical Sense Before and After Light Irradiation>

In each measurement of the central reflection wavelength before and after the light irradiation, the measurement was carried out by sandwiching a circularly polarizing plate between the sample and the light source. The helical sense of the cholesteric liquid crystalline phase before and after light irradiation was examined from the presence or absence of the reflection peak.

For the chiral agents A-2 to A-5 and the chiral agents B-1 to B-9, the helical twisting power (HTP) before and after light irradiation and the helical sense before and after light irradiation were evaluated in the same manner as in the chiral agent A-1 described above. The results are shown in Table 9.

For example, the chiral agent A-1 has a reduced helical twisting power (HTP) upon irradiation with light. In addition, the chiral agent B-1 induces a helix opposite in a direction to that of the chiral agent A-1, and has an increased helical twisting power (HTP) upon irradiation with light.

TABLE 9

| | HTP before | HTP after | | |
|---|---|---|---|---|
| Type of | light | light | Helical sense | |
| chiral | irradiation | irradiation | Before light | After light |
| agent | (μm⁻¹) | (μm⁻¹) | irradiation | irradiation |
| A-1 | 62 | 15 | Right-handed | Right-handed |
| A-2 | 75 | 51 | Right-handed | Right-handed |
| A-3 | 75 | 51 | Left-handed | Left-handed |
| A-4 | 71 | 71 | Right-handed | Right-handed |
| A-5 | 71 | 71 | Left-handed | Left-handed |
| B-1 | 14 | 53 | Left-handed | Left-handed |
| B-2 | 9 | 57 | Left-handed | Left-handed |
| B-3 | 11 | 48 | Left-handed | Left-handed |
| B-4 | 9 | 48 | Left-handed | Left-handed |
| B-5 | 12 | 52 | Left-handed | Left-handed |
| B-6 | 7 | 33 | Left-handed | Left-handed |
| B-7 | 9 | 28 | Left-handed | Left-handed |
| B-8 | 6 | 57 | Left-handed | Left-handed |
| B-9 | 8 | 22 | Right-handed | Right-handed |

[Preparation and Evaluation of Liquid Crystal Composition]

### EXAMPLE 1

<Preparation of Liquid Crystal Composition>

The liquid crystal compound LC-1, the chiral agent A-1, and the chiral agent B-1 were mixed. Then, a solvent was added to the obtained mixture to prepare a sample solution having the following composition.

| | |
|---|---|
| Liquid crystal compound LC-1 | 100 parts by mass |
| Chiral agent A-1 | 1.5 parts by mass |
| Chiral agent B-1 | 6.5 parts by mass |
| Fluorine-based surfactant shown below | 0.1 parts by mass |
| Polymerization initiator (Irg-907, | 3.0 parts by mass |
| manufactured by BASF SE) | |
| Solvent (MEK/cyclohexanone = 90/10 (mass)ratio)) | added to make a solute |
| | concentration of 30% by mass |

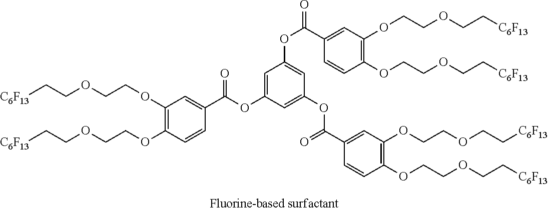

<Preparation of Cholesteric Liquid Crystal Layer>

Next, a composition for forming a polyimide alignment film SE-130 (manufactured by Nissan Chemical Corporation) was applied onto a washed glass substrate to form a coating film. The obtained coating film was baked and then subjected to a rubbing treatment to prepare a substrate with an alignment film. 30 μL of the liquid crystal composition was spin-coated on the rubbing-treated surface of this alignment film under the conditions of a rotation speed of 1000 rpm for 10 seconds to form a composition layer which was then dried (aged) at 90° C. for 1 minute to align the liquid crystal compound. At this time, it was confirmed from the polarization microscope image that the liquid crystal phase was a nematic liquid crystal phase in which a helix was not induced (therefore, the weighted average helical twisting power of the chiral agent in this liquid crystal composition was 0.0 μm⁻).

Next, the composition layer in which the liquid crystal compound was aligned was UV-irradiated with 315 nm light from a light source (2UV TRANSILLUMINATOR, manufactured by UVP, LLC) at an irradiation intensity of 30 mW/cm² for 3.3 seconds. This was followed by aging at 90° C. for 1 minute to adjust the alignment of the liquid crystal compound. Then, the composition layer after irradiation with ultraviolet rays was subjected to a curing treatment by irradiation with ultraviolet rays (mercury lamp) at an irradiation amount of 500 mJ/cm² at 25° C. under a nitrogen atmosphere to obtain a cholesteric liquid crystal layer 1 in which the cholesteric liquid crystalline phase was immobilized. The central reflection wavelength of the obtained cholesteric liquid crystal layer 1 was measured using a spectrophotometer (UV-3100, manufactured by Shimadzu Corporation), and the weighted average helical twisting power was calculated according to Expression (1B).

<SEM Observation of Cross Section>

The cholesteric liquid crystal layer 1 was cut parallel to the rubbing direction of the alignment film (the cholesteric liquid crystal layer 1 was cut perpendicular to the main surface of the cholesteric liquid crystal layer). By this cross-sectional SEM observation (cross-sectional SEM micrograph), it was confirmed that the arrangement direction of bright portions and dark portions derived from the cholesteric liquid crystalline phase was tilted by 18° with respect to the normal line of the main surface of the cholesteric liquid crystal layer 1.

<Evaluation of Diffuse Reflectivity>

From the measurement of the light transmittance, it was found that the central reflection wavelength of the cholesteric liquid crystal layer 1 was 380 nm. Using ARMN-735 (manufactured by JASCO Corporation), integral reflectance and specular reflectance (reflectance in a −10° direction) in a case where 380 nm light was incident from a direction tilted by 10° from the normal line of the cholesteric liquid crystal layer 1 were measured.

The diffuse reflectance was calculated from the following expression and evaluated according to the following evaluation standards. An “A” rating or higher is preferable from a practical point of view.

$$( Diffuse reflectance ) = < ( integral reflectance ) - ( specular reflectance ) > / ( integral reflectance ) \times 100 [ \% ]$$

The diffuse reflectivity was evaluated by the following indicators.

“A”: The diffuse reflectance is 80% or more.

“B”: The diffuse reflectance is 20% or more and less than 80%.

“C”: The diffuse reflectance is less than 20%.

<Evaluation of High Diffractivity>

Using ARMN-735 (manufactured by JASCO Corporation), the detection angle exhibiting a maximum reflectance in a case where 380 rim light was incident from the normal line of the cholesteric liquid crystal layer 1 was measured.

The diffraction angle was evaluated by the following indicators. The higher the detection angle exhibiting a maximum reflectance, the larger the angle between the normal line of the cholesteric liquid crystal layer and the reflected light, and the higher the diffractivity.

“A”: The detection angle exhibiting a maximum reflectance is 40° or more.

“B”: The detection angle exhibiting a maximum reflectance is 25° or more and less than 40°.

“C”: The detection angle exhibiting a maximum reflectance is less than 25°.

### EXAMPLES 2 TO 15, AND COMPARATIVE EXAMPLES 1 TO 5

Cholesteric liquid crystal layers in which a cholesteric liquid crystalline phase was immobilized were obtained in the same manner as in Example 1, except that the above-mentioned <sample solution composition>was changed to the formulations shown in Table 10 and Table 11.

In a case where a liquid crystal compound was aligned by drying (aging) at 90° C. for 1 minute, a nematic liquid crystal phase was not shown, but a cholesteric liquid crystalline phase was shown in Examples 13 to 15, unlike Example 1.

Table 10 and Table 11 show the shape of bright and dark lines observed by the cross-sectional SEM measurement of each cholesteric liquid crystal layer, the evaluation of diffuse reflectivity, and the evaluation of high diffractivity. The wavelength of the incidence ray used for the measurement was the central reflection wavelength of each liquid crystal layer.

Table 10 and Table 11 are shown below.

The “Relationship of helical sense” in Table 10 and Table 11 represents a relationship between the directions of helices induced by each chiral agent of the chiral agent A and the chiral agent B. In the column of “Relationship of helical sense”, it is indicated as “Same” in a case where the helical directions of the chiral agent A and the chiral agent B are the same and it is indicated as “Reverse” in a case where the helical directions of the chiral agent A and the chiral agent B are opposite to each other.

In the column of “Chiral agent B or comparative chiral agent A” in Table 10 and Table 11, Comparative Example 1, Comparative Example 2 and Comparative Example 5 correspond to the case where the comparative chiral agent A is used. Comparative Example 3 and Comparative Example 4 correspond to the case where the “Relationship of helical sense” is “Same”. Examples I to 15 correspond to the case where the chiral agent B is used.

In the column of “Helical twisting power of chiral agent A at time of exposure to light” in Table 10 and Table 11, it is indicated as “Decrease” in a case where the chiral agent A exhibits a decrease in the helical twisting power upon irradiation with light, and it is indicated as “Constant” in a case where the chiral agent A exhibits no change in the helical twisting power even upon irradiation with light. The “chiral agent A” referred to here does not include the “comparative chiral agent A”.

The tilt angle in the column of “Cross-sectional SEM image” in Table 10 and Table 11 represents a tilt angle in the arrangement direction of bright portions and dark portions derived from the cholesteric liquid crystalline phase with respect to the normal direction of the main surface of the cholesteric liquid crystal layer 1.

TABLE 10

| | | | Chiral agent B | | | | | | | | | |
|---|---|---|---|---|---|---|---|---|---|---|---|---|
| | | | or comparative | | | | | | | | | |
| | Chiral agent A | | chiral agent A | | | | Weighted average helical | | | | | |
| | | Amount | | Amount | | Helical twisting | twisting power (μm⁻¹) | | | Cross- | | |
| | | added | | added | Relationship | power of chiral | Before | After | Amount | sectional | Diffuse | Diffrac- |
| | | (parts | | (parts | of helical | agent A at time of | exposure | exposure | of in- | SEM | reflec- | tion |
| | Type | by mass) | Type | by mass) | sense | exposure to light | to light | to light | crease | image | tivity | angle |
| Example 1 | A-1 | 1.5 | B-1 | 6.5 | Reverse | Decrease | 0.0 | 40.5 | 40.5 | 18° tilted | A | A |
| Example 2 | A-2 | 0.9 | B-2 | 7.1 | Reverse | Decrease | 0.0 | 45.4 | 45.4 | 20° tilted | A | A |
| Example 3 | A-2 | 0.7 | B-6 | 7.3 | Reverse | Decrease | 0.0 | 25.8 | 25.8 | 12° tilted | A | B |
| Example 4 | A-4 | 1.3 | B-1 | 6.7 | Reverse | Constant | 0.0 | 32.6 | 32.6 | 17° tilted | A | A |
| Example 5 | A-1 | 1.4 | B-1 | 6.6 | Reverse | Decrease | 0.7 | 41.1 | 40.4 | 15° tilted | A | A |
| Example 6 | A-1 | 1.3 | B-1 | 6.7 | Reverse | Decrease | 1.5 | 41.8 | 40.3 | 11° tilted | A | B |
| Example 7 | A-1 | 0.7 | B-8 | 7.3 | Reverse | Decrease | 0.0 | 50.6 | 50.6 | 21° tilted | A | A |
| Example 8 | A-1 | 1.0 | B-4 | 7.0 | Reverse | Decrease | 0.0 | 40.0 | 40.0 | 18° tilted | A | A |
| Example 9 | A-1 | 1.0 | B-7 | 7.0 | Reverse | Decrease | 0.0 | 22.5 | 22.5 | 10° tilted | A | B |
| Example 10 | A-5 | 0.9 | B-9 | 7.1 | Reverse | Decrease | 0.0 | 17.8 | 17.8 | 10° tilted | A | B |
| Example 11 | A-1 | 1.2 | B-3 | 6.8 | Reverse | Decrease | 0.0 | 38.5 | 38.5 | 17° tilted | A | A |
| Example 12 | A-1 | 1.3 | B-5 | 6.7 | Reverse | Decrease | 0.0 | 41.1 | 41.1 | 19° tilted | A | A |
| Comparative | A-2 | 3.9 | A-5 | 4.1 | Reverse | Decrease | 0.0 | 11.7 | 11.7 | 5° tilted | B | C |
| Example 1 | | | | | | | | | | | | |
| Comparative | A-1 | 4.4 | A-3 | 3.6 | Reverse | Decrease | 0.0 | 14.9 | 14.9 | 8° tilted | B | C |
| Example 2 | | | | | | | | | | | | |

TABLE 11

| | | | Chiral agent B | | | | | | | | | |
|---|---|---|---|---|---|---|---|---|---|---|---|---|
| | | | or comparative | | | | | | | | | |
| | Chiral agent A | | chiral agent A | | | | Weighted average helical | | | | | |
| | | Amount | | Amount | | Helical twisting | twisting power (μm⁻¹) | | | Cross- | | |
| | | added | | added | Relationship | power of chiral | Before | After | In- | sectional | Diffuse | Diffrac- |
| | | (parts | | (parts | of helical | agent A at time of | exposure | exposure | crease | SEM | reflec- | tion |
| | Type | by mass) | Type | by mass) | sense | exposure to light | to light | to light | ratio | image | tivity | angle |
| Example 13 | A-1 | 1.0 | B-1 | 6.0 | Reverse | Decrease | 3.1 | 43.3 | 12.8 | Wave-like | A | C |
| Example 14 | A-2 | 0.5 | B-4 | 6.5 | Reverse | Decrease | 3.0 | 40.9 | 12.6 | Wave-like | A | C |
| Example 15 | A-1 | 0.5 | B-7 | 6.5 | Reverse | Decrease | 3.9 | 24.9 | 5.3 | Wave-like | A | C |
| Comparative | A-3 | 1.0 | B-1 | 6.0 | Same | Decrease | 22.7 | 52.7 | 1.3 | Wave-like | B | C |
| Example 3 | | | | | | | | | | | | |
| Comparative | A-5 | 1.0 | B-1 | 6.0 | Same | Constant | 22.1 | 55.6 | 1.5 | Wave-like | B | C |
| Example 4 | | | | | | | | | | | | |
| Comparative | A-1 | 3.0 | A-3 | 4.0 | Reverse | Decrease | 16.3 | 22.7 | 0.4 | Wave-like | C | C |
| Example 5 | | | | | | | | | | | | |

From the results in Table 10, the liquid crystal compositions of Examples resulted in obtaining a cholesteric liquid crystal layer exhibiting a large increase in the helical twisting power (HTP) after exposure to light and the helical twisting power (HTP) upon exposure to light, and having excellent diffuse reflectivity. In addition, from the evaluation results of the diffuse reflectivity and the diffraction angle in Table 10, it was confirmed that the liquid crystal compositions of Examples make it possible to form a cholesteric liquid crystal layer having excellent high diffraction reflectivity.

From the comparison in Table 10, it was confirmed that a cholesteric liquid crystal layer having a larger diffraction angle (that is, having excellent highly diffractive reflection) can be formed in a case where the weighted average helical twisting power of the liquid crystal composition after exposure to light is 30.0 or more. In addition, it was confirmed that a cholesteric liquid crystal layer having a larger diffraction angle (that is, having excellent highly diffractive reflection) can be formed in a case where the weighted average helical twisting power of the liquid crystal composition before exposure to light is 1.0 μm⁻¹ or less.

From the results in Table 11, the liquid crystal compositions of Examples resulted in obtaining a cholesteric liquid crystal layer exhibiting a large increase in the helical twisting power (HTP) upon exposure to light, and having excellent diffuse reflectivity. In addition, from the evaluation results of the diffuse reflectivity and the diffraction angle in Table 10, it was confirmed that the liquid crystal compositions of Examples make it possible to form a cholesteric liquid crystal layer having excellent diffuse reflectivity with suppressed reflection directivity (in other words, omnidirectional). In addition, from the comparison in Table 11, it was confirmed that a large increase ratio in the helical twisting power (HTP) after exposure to light and the helical twisting power (HTP) upon exposure to light, a larger amplitude in a wave-like structure of bright portions and dark portions derived from the cholesteric liquid crystalline phase observed by the SEM image, and better omnidirectional diffuse reflectivity can be obtained with the liquid crystal compositions of Examples, as compared with the liquid crystal composition of Comparative Example 5 (not containing the chiral agent B).

### Explanation of References

P: arrangement direction

Q: normal line

10, 20: cholesteric liquid crystal layer

10a, 20a: main surface of cholesteric liquid crystal layer

12, 22: bright portion

14, 24: dark portion

What is claimed is:

1. A liquid crystal composition comprising:
a liquid crystal compound;
a chiral agent A; and
a chiral agent B whose helical twisting power increases upon irradiation with light,
wherein the chiral agent A is a chiral agent that induces a helix in a direction opposite to that of the chiral agent B.

2. The liquid crystal composition according to claim 1,
wherein the chiral agent A is a chiral agent whose helical twisting power decreases upon irradiation with light.

3. The liquid crystal composition according to claim 1,
wherein the liquid crystal composition is nematically aligned in a case where the liquid crystal compound is aligned into a liquid crystal phase state.

4. The liquid crystal composition according to claim 1,
wherein an absolute value of a weighted average helical twisting power of a chiral agent before light irradiation in the liquid crystal composition is 0.0 to 1.5 μm⁻¹.

5. The liquid crystal composition according to claim 1,
wherein the liquid crystal composition is cholesterically aligned in the direction of the helix induced by the chiral agent B in a case where the liquid crystal compound is aligned into a liquid crystal phase state.

6. The liquid crystal composition according to claim 5,
wherein the liquid crystal composition satisfies a relationship of Expression (1D), and
each unit of the helical twisting power of the chiral agent A and the helical twisting power of the chiral agent B in Expression (1D) is and each unit of a content of the chiral agent A with respect to the liquid crystal compound and a content of the chiral agent B with respect to the liquid crystal compound in Expression (1D) is % by mass,
helical twisting power of chiral agent A×content of chiral agent A with respect to liquid crystal compound<helical twisting power of chiral agent B×content of chiral agent B with respect to liquid crystal compound Expression (1D)

7. The liquid crystal composition according to claim 1,
wherein the liquid crystal compound has at least one or more polymerizable groups.

8. The liquid crystal composition according to claim 1,
wherein at least one of the chiral agent A or the chiral agent B has a partial structure of any one of a binaphthyl partial structure, an isosorbide partial structure, or an isomannide partial structure.

9. The liquid crystal composition according to claim 1,
wherein at least one of the chiral agent A or the chiral agent B has a photoisomerizable double bond.

10. The liquid crystal composition according to claim 1,
wherein the chiral agent B is a compound represented by General Formula (1): 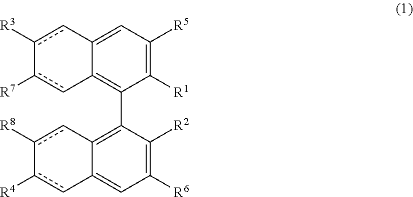
in General Formula (1), a portion where a solid line and a broken line are parallel to each other represents a single bond or a double bond, R¹ to R⁸ each independently represent a hydrogen atom or a monovalent substituent, provided that at least one of R¹, . . . , or R⁸ represents a monovalent substituent represented by General Formula (2), and R¹ and R² may be bonded to each other to form a ring structure, 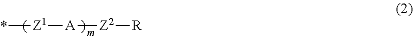
in General Formula (2), A represents an aromatic or aliphatic hydrocarbon ring group having 5 to 10 ring members, which may have a substituent, or an aromatic or aliphatic heterocyclic group having 5 to 10 ring members, which may have a substituent, Z¹ and Z² each independently represent a single bond or a divalent linking group, m represents an integer of 0 to 5, R represents a hydrogen atom or a monovalent substituent, and * represents a bonding position, and
in General Formula (2), in a case where m is an integer of 2 or more, a plurality of Z¹'s and a plurality of A′s may be respectively the same or different from each other.

11. A cholesteric liquid crystal layer formed of the liquid crystal composition according to claim 1.

12. The cholesteric liquid crystal layer according to claim 11,
wherein an arrangement direction of bright portions and dark portions derived from a cholesteric liquid crystalline phase, as observed under a scanning electron microscope in a cross section perpendicular to a main surface of the cholesteric liquid crystal layer, is tilted with respect to a normal line of the main surface of the cholesteric liquid crystal layer.

13. The cholesteric liquid crystal layer according to claim 11,
wherein bright portions and dark portions derived from a cholesteric liquid crystalline phase, as observed under a scanning electron microscope in a cross section perpendicular to a main surface of the cholesteric liquid crystal layer, are wave-like.

14. A cured substance obtained by curing the liquid crystal composition according to claim 1.

15. An optically anisotropic body formed of the liquid crystal composition according to claim 1.

16. An optically anisotropic body consisting of the cholesteric liquid crystal layer according to claim 11.

17. A method for producing a cholesteric liquid crystal layer, comprising:
a step 1 of forming a composition layer using the liquid crystal composition according to claim 1;
a step 2 of aligning the liquid crystal compound contained in the composition layer into a liquid crystal phase; and
a step 3 of irradiating at least a partial region of the composition layer with light to increase the helical twisting power of the chiral agent B in a light-irradiated region.

18. The method for producing a cholesteric liquid crystal layer according to claim 17,
wherein the step 2 is a step of aligning the liquid crystal compound contained in the composition layer into a nematic liquid crystal phase,
the step 3 is a step of increasing the helical twisting power of the chiral agent B in the light-irradiated region to bring an alignment state of the liquid crystal compound into a cholesteric liquid crystalline phase, and
the cholesteric liquid crystal layer is obtained through the steps 1 to 3 such that an arrangement direction of bright portions and dark portions derived from the cholesteric liquid crystalline phase, as observed under a scanning electron microscope in a cross section perpendicular to a main surface of the cholesteric liquid crystal layer, is tilted with respect to a normal line of the main surface of the cholesteric liquid crystal layer.

19. The method for producing a cholesteric liquid crystal layer according to claim 17,
wherein the step 2 is a step of aligning the liquid crystal compound contained in the composition layer into a cholesteric liquid crystalline phase,
the step 3 is a step of increasing the helical twisting power of the chiral agent B in the light-irradiated region to reduce a helical pitch of the cholesteric liquid crystalline phase, and
the cholesteric liquid crystal layer is obtained through the steps 1 to 3 such that bright portions and dark portions derived from the cholesteric liquid crystalline phase, as observed under a scanning electron microscope in a cross section perpendicular to a main surface of the cholesteric liquid crystal layer, are wave-like.

20. The liquid crystal composition according to claim 2,
wherein the liquid crystal composition is nematically aligned in a case where the liquid crystal compound is aligned into a liquid crystal phase state.
